(19) United States
(12) Patent Application Publication
(10) Pub. No.: US 2026/0086339 A1
(43) Pub. Date: Mar. 26, 2026

(54) ATTACHMENT OPTICAL SYSTEM

(71) Applicant: NIKON CORPORATION, Tokyo (JP)

(72) Inventor: Hidetsugu TAKAGI, Yokohama-shi (JP)

(73) Assignee: NIKON CORPORATION, Tokyo (JP)

(21) Appl. No.: 19/400,933

(22) Filed: Nov. 25, 2025

Related U.S. Application Data
(63) Continuation of application No. PCT/JP2024/013697, filed on Apr. 3, 2024.

(30) Foreign Application Priority Data
May 26, 2023 (JP) 2023-086725

(51) Int. Cl. G02B 21/00; G02B 21/02

(52) U.S. Cl. CPC G02B 21/0028; G02B 21/0076; G02B 21/025

(57) ABSTRACT

An attachment optical system (AL) is an attachment optical system for a microscope detachably mounted between an objective lens (OL) that receives light from an object and converts the light into parallel light and an image forming lens that forms an image with the light from the objective lens (OL), the attachment optical system comprising: a first optical element (EL1) having negative refractive power; and a second optical element (EL2) having positive refractive power.

### CROSS-REFERENCE TO RELATED APPLICATIONS

This application is a continuation application, claiming priority under § 365 (c), of International Application No. PCT/JP2024/013697, filed on Apr. 3, 2024, which is based on and claims the benefit of Japanese Patent Application Number 2023-086725 filed on May 26, 2023, the disclosures of which is incorporated by reference herein in its entirety.

### TECHNICAL FIELD

The present invention relates to an attachment optical system for a microscope.

### TECHNICAL BACKGROUND

Conventionally, various microscopes have been proposed that include an objective lens that receives light from an object and converts the light into parallel light and an image forming lens that forms an image with the light from the objective lens (for example, see Patent Literature 1). In these microscopes, it is required to excellently correct various aberrations.

### PRIOR ARTS LIST

### Patent Document

Patent Literature 1: Japanese Laid-Open Patent Publication No. 2003-195175

### SUMMARY OF THE INVENTION

An attachment optical system according to the present invention is an attachment optical system for a microscope detachably mounted between an objective lens that receives light from an object and converts the light into parallel light and an image forming lens that forms an image with the light from the objective lens, the attachment optical system comprising: a first optical element having negative refractive power; and a second optical element having positive refractive power.

### BRIEF DESCRIPTION OF THE DRAWINGS

FIG. 1 is a schematic configuration diagram showing a confocal fluorescence microscope;

FIG. 2 is a schematic diagram showing a vicinity of a revolver in the confocal fluorescence microscope;

FIG. 3 is a cross-sectional view showing a configuration of an attachment optical system and an objective lens according to Example 1;

FIG. 4 is a graph showing various aberrations of the attachment optical system according to Example 1 when silicone is used as an immersion liquid;

FIG. 5 is a graph showing various aberrations of the attachment optical system according to Example 1 when glycerin is used as an immersion liquid;

FIG. 6 is a graph showing various aberrations of the attachment optical system according to Example 1 when oil is used as an immersion liquid;

FIG. 7 is a graph showing various aberrations of the attachment optical system according to Example 1 when water is used as an immersion liquid;

FIG. 8 is a graph showing a coma aberration of the attachment optical system according to Example 1 when silicone is used as an immersion liquid;

FIG. 9 is a graph showing a coma aberration of the attachment optical system according to Example 1 when glycerin is used as an immersion liquid;

FIG. 10 is a graph showing a coma aberration of the attachment optical system according to Example 1 when oil is used as an immersion liquid;

FIG. 11 is a graph showing a coma aberration of the attachment optical system according to Example 1 when water is used as an immersion liquid;

FIG. 12 is a cross-sectional view showing a configuration of an attachment optical system and an objective lens according to Example 2;

FIG. 13 is a graph showing various aberrations of the attachment optical system according to Example 2 when silicone is used as an immersion liquid;

FIG. 14 is a graph showing various aberrations of the attachment optical system according to Example 2 when glycerin is used as an immersion liquid;

FIG. 15 is a graph showing various aberrations of the attachment optical system according to Example 2 when oil is used as an immersion liquid;

FIG. 16 is a graph showing various aberrations of the attachment optical system according to Example 2 when water is used as an immersion liquid;

FIG. 17 is a graph showing a coma aberration of the attachment optical system according to Example 2 when silicone is used as an immersion liquid;

FIG. 18 is a graph showing a coma aberration of the attachment optical system according to Example 2 when glycerin is used as an immersion liquid;

FIG. 19 is a graph showing a coma aberration of the attachment optical system according to Example 2 when oil is used as an immersion liquid;

FIG. 20 is a graph showing a coma aberration of the attachment optical system according to Example 2 when water is used as an immersion liquid;

FIG. 21 is a cross-sectional view showing a configuration of an attachment optical system and an objective lens according to Example 3;

FIG. 22 is a graph showing various aberrations of the attachment optical system according to Example 3 when an object is observed at a water depth of 0.5 mm;

FIG. 23 is a graph showing various aberrations of the attachment optical system according to Example 3 when an object is observed at a water depth of 2.5 mm;

FIG. 24 is a graph showing various aberrations of the attachment optical system according to Example 3 when an object is observed at a water depth of 3.5 mm;

FIG. 25 is a graph showing a coma aberration of the attachment optical system according to Example 3 when an object is observed at a water depth of 0.5 mm;

FIG. 26 is a graph showing a coma aberration of the attachment optical system according to Example 3 when an object is observed at a water depth of 2.5 mm;

FIG. 27 is a graph showing a coma aberration of the attachment optical system according to Example 3 when an object is observed at a water depth of 3.5 mm;

FIG. 28 is a cross-sectional view showing a configuration of an attachment optical system and an objective lens according to Example 4;

FIG. 29 is a graph showing various aberrations of the attachment optical system according to Example 4 when silicone is used as an immersion liquid;

FIG. 30 is a graph showing various aberrations of the attachment optical system according to Example 4 when glycerin is used as an immersion liquid;

FIG. 31 is a graph showing various aberrations of the attachment optical system according to Example 4 when oil is used as an immersion liquid;

FIG. 32 is a graph showing various aberrations of the attachment optical system according to Example 4 when water is used as an immersion liquid;

FIG. 33 is a graph showing a coma aberration of the attachment optical system according to Example 4 when silicone is used as an immersion liquid;

FIG. 34 is a graph showing a coma aberration of the attachment optical system according to Example 4 when glycerin is used as an immersion liquid;

FIG. 35 is a graph showing a coma aberration of the attachment optical system according to Example 4 when oil is used as an immersion liquid;

FIG. 36 is a graph showing a coma aberration of the attachment optical system according to Example 4 when water is used as an immersion liquid; and

FIG. 37 is a cross-sectional view showing a configuration of an image forming lens.

### DESCRIPTION OF THE EMBODIMENTS

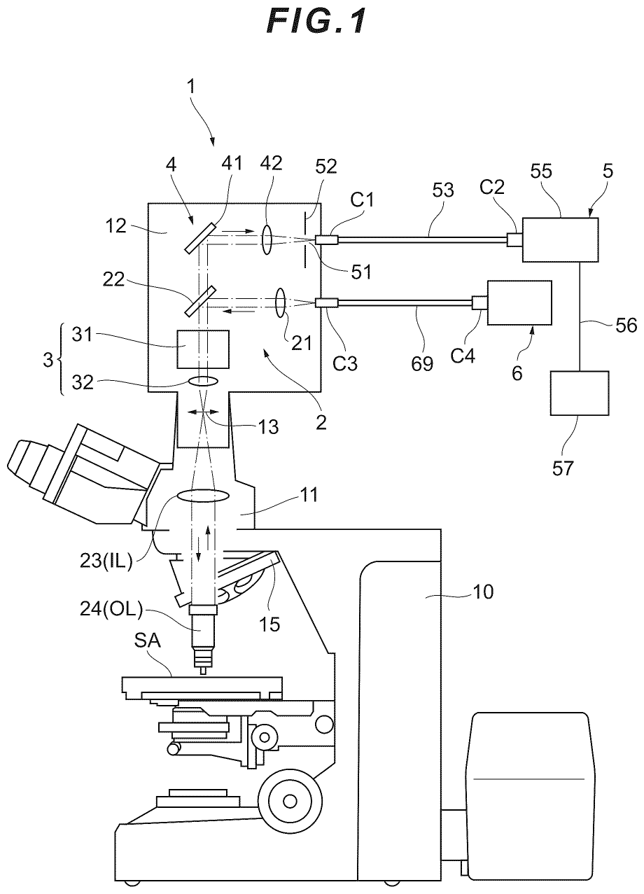

Hereinafter, preferred embodiments according to the present invention will be described. First, a description will be given with respect to a confocal fluorescence microscope to which an attachment optical system according to the present embodiments is attachable. As shown in FIG. 1, the confocal fluorescence microscope 1 comprises an excitation light introducing part 2 that guides laser light for illumination from a light source unit 6 onto a sample SA, a scanning device 3 that deflects the laser light condensed on the sample SA and scans the laser light on the sample SA, a photodetector 5 that detects a light intensity signal from the sample SA, and a collective optical system 4 that guides the light from the sample SA to the photodetector 5.

The light source unit 6 may be provided in the confocal fluorescence microscope 1 or be provided separately from the confocal fluorescence microscope 1. The light source unit 6 comprises a laser light source (not shown), a beam diameter adjusting mechanism (not shown), and the like. The light source unit 6 oscillates the laser light for illumination.

The excitation light introducing part 2 comprises a collimator lens 21, a dichroic mirror 22, an image forming lens 23, and an objective lens 24. The collimator lens 21 and the dichroic mirror 22 are arranged inside a microscope housing part 12 provided at a top of a lens barrel part 11 in a microscope body 10. The light source unit 6 and the microscope housing part 12 are connected by an optical fiber 69 using connectors C3 and C4. The collimator lens 21 converts the laser light (flux of light) oscillated from the light source unit 6 into parallel light. The dichroic mirror 22 reflects the laser light from the collimator lens 21 toward the sample SA. The laser light reflected by the dichroic mirror 22 is collected onto the sample SA by the image forming lens 23 and the objective lens 24. The image forming lens 23 is arranged inside the lens barrel part 11 of the microscope body 10. The image forming lens 23 is also referred to as a second objective lens. The objective lens 24 is detachably attached to a revolver 15 provided at a bottom of the lens barrel part 11.

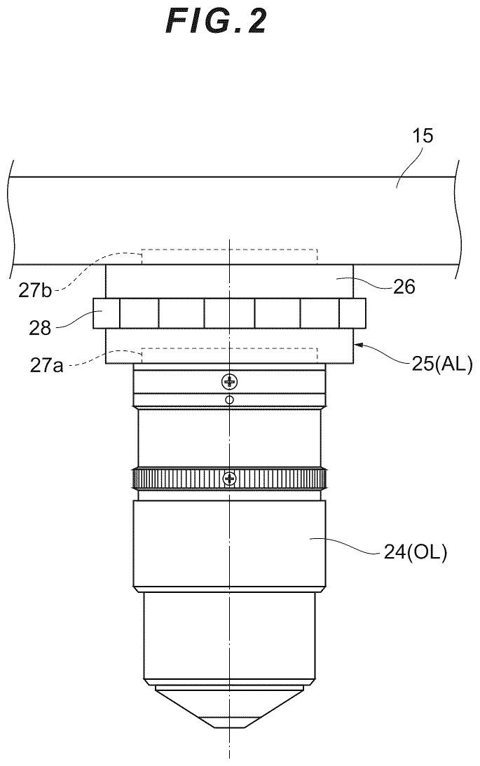

In addition, as shown in FIG. 2, the objective lens 24 can also be detachably attached to the revolver 15 together with the attachment optical system 25. In this way, the attachment optical system 25 is detachably mounted between the objective lens 24 and the image forming lens 23. When the attachment optical system 25 is mounted between the objective lens 24 and the image forming lens 23, the laser light reflected by the dichroic mirror 22 is collected onto the sample SA by the image forming lens 23, the attachment optical system 25, and the objective lens 24. An optical element constituting the attachment optical system 25 is housed in an optical element housing 26 formed in a cylindrical shape. A first screw part 27a is formed on one end side (a side of the objective lens 24) of the optical element housing 26, and a second screw part 27b is formed on the other side (a side opposite to the objective lens 24) of the optical element housing 26. The first screw part 27a is a female screw that can be threaded into a screw part (not shown) of the objective lens 24. The second screw part 27b is a male screw that can be threaded into a screw part (not shown) of the revolver 15. Furthermore, a correction collar 28, which rotates to correct aberration, is provided on a side of the optical element housing 26.

As shown in FIG. 1, the scanning device 3 comprises a scanning mechanism (scanner) 31 and a scanning optical system 32. The scanning device 3 is arranged between the dichroic mirror 22 provided inside the microscope housing part 12 and the image forming lens 23. The scanning mechanism (scanner) 31 includes, for example, a galvanometer mirror (not shown) or a resonant mirror (not shown). The scanning mechanism (scanner) 31 deflects incident laser light. In other words, the scanning mechanism (scanner) 31 deflects the laser light collected onto the sample SA and scans the laser light on the sample SA. The scanning optical system 32 is an optical system provided between the scanning mechanism (scanner) 31 and the image forming lens 23. The scanning optical system 32 is an optical system in which a focal position of the scanning optical system 32 is located on an image forming surface 13 (also referred to as a primary image surface) conjugate with the sample SA (scanning surface of the sample SA).

The collective optical system 4 comprises the objective lens 24, the image forming lens 23, a total reflection mirror 41, and a collecting lens 42. The objective lens 24 receives fluorescent light generated in the sample SA and converts the fluorescent light into parallel light. The image forming lens 23 collects once the fluorescent light (parallel light), which is emitted from the objective lens 24, onto the image forming surface 13 (primary image surface) to form an image. In addition, when the attachment optical system 25 is mounted between the objective lens 24 and the image forming lens 23, the image forming lens 23 collects once the fluorescent light, which has passed through the attachment optical system 25, from the objective lens 24 onto the image forming surface 13 to form an image. Thus, the fluorescent light generated from the sample SA and passing through the image forming lens 23 is once condensed onto the image forming surface 13, and reaches the total reflection mirror 41 through the scanning device 3 and the dichroic mirror 22. The total reflection mirror 41 and the collecting lens 42 are arranged above the dichroic mirror 22 inside the microscope housing part 12. The total reflection mirror 41 reflects the fluorescent light generated from the sample SA and passing through the image forming lens 23. The collecting lens 42 collects the fluorescent light reflected by the total reflection mirror 41 onto a light shielding panel 52 including a pinhole 51 (aperture).

The photodetector 5 comprises the light shielding panel 52 having the pinhole 51, an optical fiber 53, and a detection unit 55. The optical fiber 53 is connected to the microscope housing part 12 and the detection unit 55 using connectors C1 and C2. The light (fluorescent light) that has passed through the pinhole 51 is incident on the optical fiber 53. The detection unit 55 detects the light (fluorescent light) that has passed through the pinhole 51 and the optical fiber 53. The detection unit 55 is electrically connected to a processing unit 57 via a cable 56. The processing unit 57 performs image processing (of the sample SA) based on a detection signal detected by the detection unit 55, and an observation image of the sample SA obtained by image processing of the processing unit 57 is displayed on a monitor (not shown).

Here, the laser light from the scanning device 3 is once collected onto the image forming surface 13 (primary image surface) and then collected again onto the sample SA by the image forming lens 23 and the objective lens 24. Furthermore, when the attachment optical system 25 is mounted between the objective lens 24 and the image forming lens 23, the laser light from the scanning device 3 is once collected onto the image forming surface 13 and then collected again onto the sample SA by the image forming lens 23, the attachment optical system 25, and the objective lens 24. In other words, the scanning surface of the sample SA, the image forming surface 13, and the pinhole 51 are in conjugate relation with each other. Therefore, the image forming lens 23 and (the attachment optical system 25 and) the objective lens 24 are configured to collect light onto the sample SA, whereby it becomes possible to pass the fluorescent light generated on the scanning surface of the sample SA, among the light (fluorescent light) coming from the sample SA, through the pinhole 51.

Although the confocal fluorescence microscope 1 has been described as an example of the microscope on which the attachment optical system according to the present embodiment can be mounted, the present embodiment is not limited thereto. For example, an example of the microscope, on which the attachment optical system according to the present embodiment is mounted, may be a multi-photon excitation microscope, a super-resolution microscope, an observation microscope, or the like. The confocal fluorescence microscope 1 may be an upright microscope or an inverted microscope.

An attachment optical system AL to be described below can be used as the attachment optical system 25 that can be mounted between the objective lens 24 and the image forming lens 23 of such a confocal fluorescence microscope 1. Furthermore, an objective lens OL and an image forming lens IL to be described below can be used as the objective lens 24 and the image forming lens 23 of such a confocal fluorescence microscope 1.

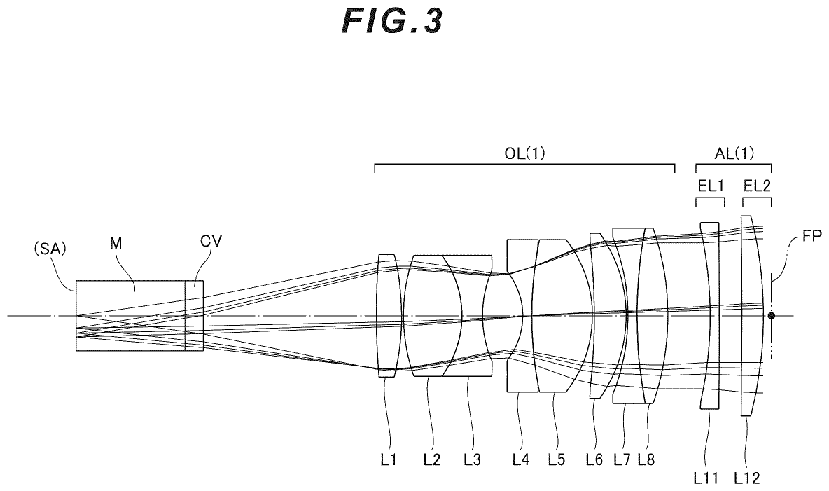

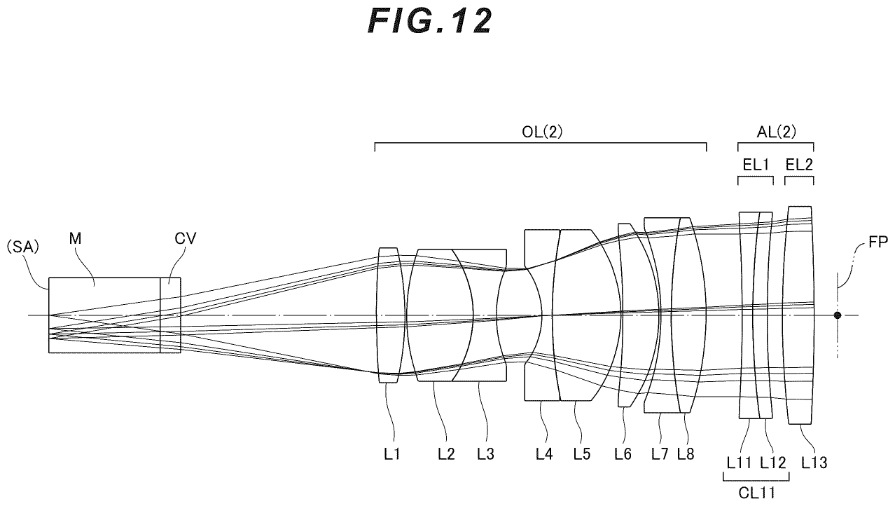

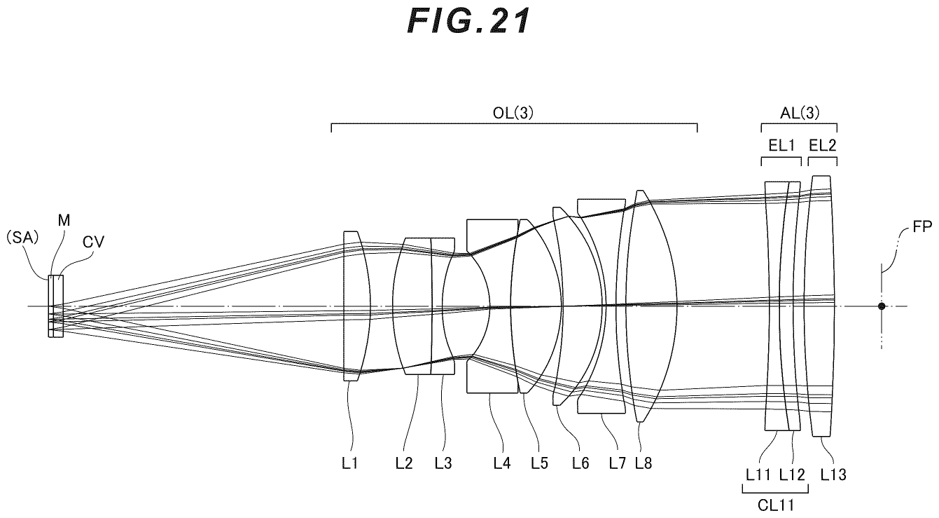

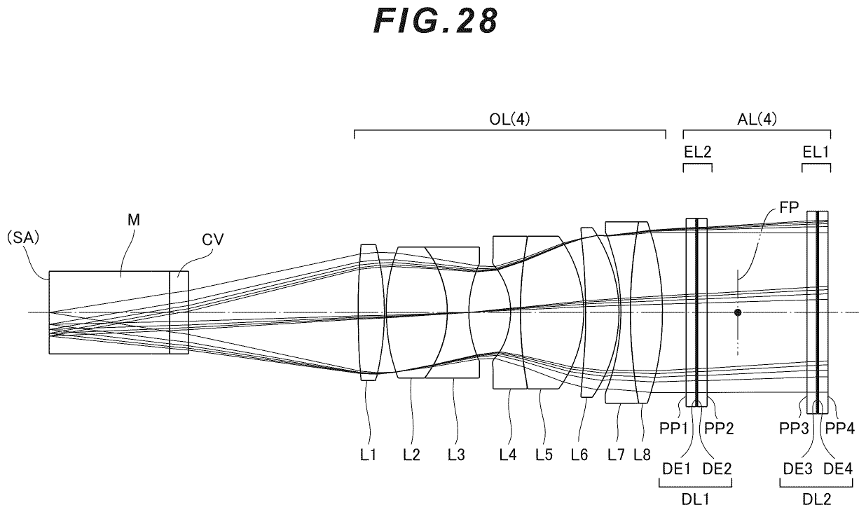

Next, the attachment optical system AL according to the present embodiment will be described. As an example of the attachment optical system AL according to the present embodiment, an attachment optical system AL(1) shown in FIG. 3 includes a first optical element EL1 having negative refractive power and a second optical element EL2 having positive refractive power. Since the attachment optical system AL according to the present embodiment is detachably mounted between the objective lens OL and the image forming lens IL, when one type of objective lens is used to accommodate a plurality of types of immersion liquids, it is possible to excellently correct a longitudinal chromatic aberration and a spherical aberration that occurs depending on the type of immersion liquid. In addition, since the attachment optical system AL according to the present embodiment is detachably mounted between the objective lens OL and the image forming lens IL, it is possible to excellently correct aberrations (longitudinal chromatic aberration and spherical aberration) that occurs depending on a depth of the immersion liquid. The attachment optical system AL according to the present embodiment may be an attachment optical system AL(2) shown in FIG. 12, may be an attachment optical system AL(3) shown in FIG. 21, or may be an attachment optical system AL(4) shown in FIG. 28.

In the attachment optical system AL according to the present embodiment, at least one of the first optical element EL1 and the second optical element EL2 may be movable along an optical axis. Thus, it is possible to excellently correct a longitudinal chromatic aberration that occurs depending on a refractive index and an Abbe number of the sample or the immersion liquid. Either of the first optical element EL1 and the second optical element EL2 may be movable along the optical axis. Each of the first optical element EL1 and the second optical element EL2 may be movable along the optical axis.

In the attachment optical system AL according to the present embodiment, at least one of the first optical element EL1 and the second optical element EL2 may be movable in a direction perpendicular to the optical axis. Thus, it is possible to excellently correct an aberration due to decentering of the objective lens or the image forming lens (microscope). Either of the first optical element EL1 and the second optical element EL2 may be movable in the direction perpendicular to the optical axis. Each of the first optical element EL1 and the second optical element EL2 may be movable in the direction perpendicular to the optical axis.

The attachment optical system AL according to the present embodiment may satisfy the following conditional expression (1).

$$2 < \vert fA \vert / TLA < 10000 \qquad ( 1 )$$

where, fA: a focal length of the attachment optical system AL
   TLA: an entire length of the attachment optical system AL

The conditional expression (1) is to define an appropriate relation between a focal length of the attachment optical system AL and an entire length of the attachment optical system AL. When the conditional expression (1) is satisfied, a total magnification of the microscope does not change significantly even when the attachment optical system AL is mounted, whereby it is possible to prevent fluctuations in a field-of-view range of the microscope due to the attachment of the attachment optical system AL. When a lower limit value in the conditional expression (1) is set to 25 or 100, the effect of the present embodiment can be made more reliable. When an upper limit value in the conditional expression (1) is set to 7000, 5000, 3000, or even 1500, the effect of the present embodiment can be made more reliable.

In the attachment optical system AL according to the present embodiment, the first optical element EL1 and the second optical element EL2 may be arranged along the optical axis in this order from the objective lens OL. Thus, light rays passing through the attachment optical system AL is distant from the optical axis, whereby it is possible to excellently correct a spherical aberration. In addition, it is possible to excellently correct aberrations (longitudinal chromatic aberration and spherical aberration) that occurs depending on the type of the sample or the immersion liquid.

In the attachment optical system AL according to the present embodiment, the second optical element EL2 may be one positive lens or one cemented lens including at least a positive lens, and may satisfy the following conditional expression (2).

$$35 < ν dP < 101 \qquad ( 2 )$$

where, νdP: Abbe number of a positive lens

The conditional expression (2) is to define an appropriate range for an Abbe number of a positive lens. When the conditional expression (2) is satisfied, it is possible to excellently correct a longitudinal chromatic aberration and a spherical aberration. When a lower limit value in the conditional expression (2) is set to 40 or 45, the effect of the present embodiment can be made more reliable. When an upper limit value in the conditional expression (2) is set to 96, 90, or even 80, the effect of the present embodiment can be made more reliable. In addition, the second optical element EL2 may be one positive lens.

In the attachment optical system AL according to the present embodiment, the first optical element EL1 may be one negative lens, or may be one cemented lens including at least a negative lens, and the second optical element EL2 may be one positive lens or may be one cemented lens including at least a positive lens, and may satisfy the following conditional expression (3).

$$0 \leq ν dP - ν dN < 30 \qquad ( 3 )$$

where, νdP: Abbe number of a positive lens
   νdN: Abbe number of a negative lens

The conditional expression (3) is to define an appropriate relation between an Abbe number of a positive lens and an Abbe number of a negative lens. When the conditional expression (3) is satisfied, it is possible to excellently correct a longitudinal chromatic aberration. When the corresponding value in the conditional expression (3) is outside the above range, a difference in Abbe number between the positive lens and the negative lens becomes too large, resulting in excessive aberration correction due to the attachment optical system AL and making it difficult to correct the longitudinal chromatic aberration excellently. When an upper limit value in the conditional expression (3) is set to 25, 20, or even 15, the effect of the present embodiment can be made more reliable. In addition, the second optical element EL2 may be one positive lens.

In the attachment optical system AL according to the present embodiment, the first optical element EL1 may be a diffractive optical element having negative refractive power, the second optical element EL2 may be a diffractive optical element having positive refractive power, and the diffractive optical element having positive refractive power and the diffractive optical element having negative refractive power may be arranged along the optical axis in this order from the objective lens OL. Thus, it is possible to excellently correct a longitudinal chromatic aberration, which occurs depending on the refractive index and the Abbe number of the sample or the immersion liquid, using a diffraction phenomenon.

The attachment optical system AL according to the present embodiment may satisfy the following conditional expression (4).

$$0.1 < δ A / TLA < 4. 5 \qquad ( 4 )$$

where, δA: a distance on the optical axis from an optical surface closest to the objective lens OL in the attachment optical system AL to a back-side focal position FP of the objective lens OL.

TLA: an entire length of the attachment optical system AL

The conditional expression (4) is to define an appropriate relation between a distance on the optical axis from an optical surface closest to the objective lens OL in the attachment optical system AL to a back-side focal position FP of the objective lens OL, and the entire length of the attachment optical system AL. The back-side focal position FP of the objective lens OL may be located closer to the image forming lens IL than the optical surface closest to the objective lens OL in the attachment optical system AL. The back-side focal position FP of the objective lens OL may be located closer to the objective lens OL than the optical surface closest to the objective lens OL in the attachment optical system AL. The distance on the optical axis from the optical surface closest to the objective lens OL in the attachment optical system AL to the back-side focal position FP of the objective lens OL indicates an absolute value of the distance on the optical axis from the optical surface closest to the objective lens OL in the attachment optical system AL to the back-side focal position FP of the objective lens OL. When the conditional expression (4) is satisfied, it is possible to excellently correct a longitudinal chromatic aberration, which occurs depending on the refractive index and the Abbe number of the sample or the immersion liquid, while making a chromatic aberration of magnification small. When a lower limit value in the conditional expression (4) is set to 0.2, 0.3, or even 0.5, the effect of the present embodiment can be made more reliable. When an upper limit value in the conditional expression (4) is set to 4, 3.5, or even 3, the effect of the present embodiment can be made more reliable.

The attachment optical system AL according to the present embodiment may satisfy the following conditional expression (5).

$$0.05 < TLA / TLB < 0.75 \qquad ( 5 )$$

where, TLA: an entire length of the attachment optical system AL

TLB: an entire length of the objective lens OL

The conditional expression (5) is to define an appropriate relation between the entire length of the attachment optical system AL and the entire length of the objective lens OL. When the conditional expression (5) is satisfied, the entire length of the attachment optical system AL is shortened, whereby it is possible to minimize the change in the distance between the objective lens OL and the sample due to the attachment of the attachment optical system AL. For this reason, an existing microscope can be used as a microscope to which the objective lens OL can be attached together with the attachment optical system AL. When a lower limit value in the conditional expression (5) is set to 0.1 or even 0.15, the effect of the present embodiment can be made more reliable. When an upper limit value in the conditional expression (5) is set to 0.6 or even 0.5, the effect of the present embodiment can be made more reliable.

In the present embodiment, the attachment optical system AL may be designed such that the entire length of the objective lens OL is an integer multiple (for example, 2 times, 3 times, 4 times, 5 times, or 6 times) of the entire length of the attachment optical system AL. In actual objective lens and attachment optical system, it is extremely difficult from the viewpoint of manufacturing technique or measurement technique to strictly set the ratio between the entire length of the objective lens and the entire length of the attachment optical system to an integer multiple. Therefore, the ratio between the entire length of the objective lens and the entire length of the attachment optical system may be approximately an integer multiple without departing from the scope of the present embodiment. In other words, the concept of integer multiple in the present embodiment includes a substantially integral multiple, and includes at least a range within which an accuracy range in manufacturing technique can be obtained. For example, the ratio between the entire length of the objective lens and the entire length of the attachment optical system may be a (mathematical) magnification in a range of an integer multiple±10%, a magnification in a range of an integer multiple±5%, a magnification in a range of an integer multiple±3%, and a magnification in a range of an integer multiple±1%, which are considered to be approximately integer multiples and are included in the range of integer multiples in the present embodiment.

### EXAMPLE

Hereinafter, Examples of the attachment optical system AL according to the present embodiment will be described with reference to the drawings. FIGS. 3, 12, 21, and 28 are optical path diagrams showing configurations of attachment optical systems AL {AL(1) to AL(4)} and objective lenses OL {OL(1) to OL(4)} according to Examples 1 to 4. In FIGS. 3, 12, 21, and 28, each optical element is represented by a combination of a symbol L and numerals (or alphabets). In this case, to prevent complication due to an increase in type and number of symbol and numerals, lenses and the like are independently represented in each Example by different combinations of symbols and numerals. For this reason, even when the same combination of symbols and numerals is used in respective Examples, it does not indicate to the same combination.

Tables 1 to 4 are shown below, with Table 1 showing data on various specifications for Example 1, Table 2 showing data on various specifications for Example 2, Table 3 showing data on various specifications for Example 3, and Table 4 showing data on various specifications for Example 4. In each Example, the following calculation targets are selected for the aberration characteristics: d-line (wavelength λ=587.6 nm); C-line (wavelength λ=656.3 nm); F-line (wavelength)=486.1 nm); and g-line (wavelength λ=435.8 nm).

In the table of [General Data], a symbol “NA” represents a numerical aperture of the objective lens in a state where the attachment optical system is mounted. A symbol “B” represents a magnification of the objective lens in a state where the attachment optical system is mounted. A symbol “f” represents a focal length of the attachment optical system. A symbol “Q” represents a pupil diameter of the attachment optical system. A symbol “TLA” represents the entire length of the attachment optical system (the distance on the optical axis from the optical surface closest to the objective lens in the attachment optical system to the optical surface closest to the image forming lens). A symbol “TLB” represents the entire length of the objective lens (the distance on the optical axis from the lens surface in the objective lens closest to the object to the lens surface closest to the image). A symbol “SA” represents the distance on the optical axis from the optical surface closest to the objective lens in the attachment optical system to the back-side focal position of the objective lens.

In the table of [Lens Data], surface numbers represent the order of the lens surfaces from the object, a symbol “R” represents a radius of curvature corresponding to each of the surface numbers (a positive value being assigned to a lens surface having a convex surface facing the object), a symbol “D” represents a lens thickness on the optical axis or an air distance corresponding to each of the surface numbers, a symbol “nd” represents a refractive index with respect to the d-line (wavelength %=587.6 nm) of an optical material corresponding to each of the surface numbers, an a symbol “νd” represents an Abbe number based on the d-line of the optical material corresponding to each of the surface numbers. A symbol “∞” in the radius of curvature represents a plane or an aperture. In addition, a refractive index of air, nd=1.00000, is not described. When the optical surface is a diffractive optical surface, the surface number is denoted by a symbol *, and a paraxial radius of curvature is indicated in a column of the radius of curvature R.

When the attachment optical system includes a diffractive optical element, a phase coefficient of a diffractive optical surface calculated using a phase function method is shown in [Diffractive Optical Surface Data]. A reference wavelength for the phase coefficient is 587.6 nm. The phase coefficient “E-n” indicates “×10⁻ⁿ”. For example, 1.234E-05=1.234×10⁻⁵. A phase polynomial is expressed by the following Formula (A) to determine a shape of the diffractive optical surface.

$$\begin{matrix}[ Formula 1 ] & \\ ϕ = {\sum }_{n} {C}_{n} {r}^{n} & ( A )\end{matrix}$$

The table of [Variable Distance Data] indicates a surface distance at a surface number “i” where the surface distance in the table of [Lens Data] is indicated by (Di). The table of [Variable Distance Data] indicates a surface distance depending on the type or depth of the immersion liquid. In the table of [Variable Distance Data], a symbol “ndM” represents a refractive index with respect to the d-line (wavelength λ=587.6 nm) of the corresponding immersion liquid. A symbol “νdM” represents an Abbe number based on the d-line of the corresponding immersion liquid.

Hereinafter, for all the general data values, unless otherwise specified, the focal length f, the radius of curvature R, the surface distance D, other lengths, and the like are generally expressed in “mm”, but are not limited thereto in terms that the same optical performance can be obtained even when the optical system is proportionally enlarged or reduced.

The above-description regarding the tables is common to all Examples, and will not be given repeatedly below.

### Example 1

Example 1 will be described with reference to FIGS. 3 to 11 and Table 1. FIG. 3 is a cross-sectional view showing a configuration of an attachment optical system and an objective lens according to Example 1. An attachment optical system AL(1) according to Example 1 is detachably mounted between an objective lens OL(1) and an image forming lens (not shown in FIG. 3) according to Example 1. The objective lens OL(1) according to Example 1 receives light from an object (sample SA) and converts the light into parallel light. The light (parallel light) from the objective lens OL(1) according to Example 1 is incident to the attachment optical system AL(1) according to Example 1. Air is filled between a tip of the objective lens OL(1) according to Example 1 and a cover glass CV that covers the object. Furthermore, an immersion liquid M is filled between the cover glass CV and the object. An example of the immersion liquid M includes, for example, silicone, glycerin, oil, or water.

The objective lens OL(1) according to Example 1 comprises first to eighth lenses L1 to L8 which are disposed in order from the object on an optical axis. The first lens L1, the second lens L2, the fifth lens L5, and the eighth lens L8 are biconvex positive lenses. The third lens L3, the fourth lens L4, and the seventh lens L7 are biconcave negative lenses. The sixth lens L6 is a positive meniscus lens having a concave surface facing the object. The second lens L2 and the third lens L3 are cemented. The fourth lens L4 and the fifth lens L5 are cemented. The seventh lens L7 and the eighth lens L8 are cemented.

The attachment optical system AL(1) according to Example 1 comprises a negative meniscus lens L11 having a concave surface facing the object and a positive meniscus lens L12 having a concave surface facing the object which are disposed in order from the object (the objective lens OL(1)) on the optical axis. In Example 1, the negative lens L11 is equivalent to the first optical element EL1 described above, and the positive lens L12 is equivalent to the second optical element EL2 described above. A back-side focal position FP of the objective lens OL(1) according to Example 1 is located near an image (image forming lens) of the positive lens L12. In addition, the correction collar 28 (see FIG. 2) is configured to be rotated around the optical axis depending on the type and depth of the immersion liquid M and the thickness of the cover glass CV, whereby the negative lens L11 can be moved along the optical axis.

In Example 1, the refractive index of the silicone to the d-line (wavelength λ=587.6 nm) is 1.4041. The refractive index of the glycerin to the d-line (wavelength λ=587.6 nm) is 1.4738. The refractive index of the oil to the d-line (wavelength λ=587.6 nm) is 1.5150. The refractive index of the water to the d-line (wavelength λ=587.6 nm) is 1.3326. The refractive index of the cover glass CV to the d-line (wavelength λ=587.6 nm) is 1.5244.

Table 1 below shows data values of the attachment optical system and the objective lens according to Example 1. Here, a first surface is an object surface, and a second surface and an eighteenth surface are virtual surfaces.

TABLE 1
[General Data]

| | |
|---|---|
| NA = 0.200 | β = 4.731 |
| f = −6999.947 | φ = 16.911 |
| TLA = 5.843 | TLB = 32.00 |
| δA = 7.064 | |

[Lens Data]

| Surface | | | | |
|---|---|---|---|---|
| number | R | D | nd | νd |
| 1 | ∞ | (D1) | (ndM) | (νdM) |
| 2 | ∞ | 10.800 | (ndM) | (νdM) |
| 3 | ∞ | 2.000 | 1.5244 | 54.3 |
| 4 | ∞ | 19.000 | | |
| 5 | 81.180 | 2.762 | 1.804 | 46.6 |
| 6 | −28.510 | 0.200 | | |
| 7 | 19.709 | 6.427 | 1.5932 | 67.9 |
| 8 | −11.033 | 2.258 | 1.5481 | 45.8 |
| 9 | 12.498 | 4.417 | | |
| 10 | −7.790 | 1.000 | 1.738 | 32.3 |
| 11 | 42.222 | 6.661 | 1.4978 | 82.6 |
| 12 | −13.523 | 0.200 | | |
| 13 | −71.317 | 3.500 | 1.7408 | 27.7 |
| 14 | −15.666 | 0.200 | | |
| 15 | −23.138 | 1.000 | 1.6127 | 44.5 |
| 16 | 52.277 | 3.376 | 1.4978 | 82.6 |
| 17 | −29.535 | 0.200 | | |
| 18 | ∞ | (D18) | | |
| 19 | −43.191 | 1.000 | 1.5168 | 64.1 |
| 20 | −1610.538 | (D20) | | |
| 21 | −584.564 | 2.360 | 1.5168 | 64.1 |
| 22 | −43.970 | 100.000 | | |

[Variable distance data]

| | D1 | D18 | D20 | ndM | νdM |
|---|---|---|---|---|---|
| Silicone | 1.200 | 4.457 | 2.483 | 1.4041 | 52.0 |
| Glycerin | 1.743 | 4.287 | 2.652 | 1.4738 | 60.6 |
| Oil | 1.502 | 2.486 | 4.454 | 1.5150 | 43.1 |
| Water | 0.952 | 5.766 | 1.174 | 1.3326 | 55.9 |

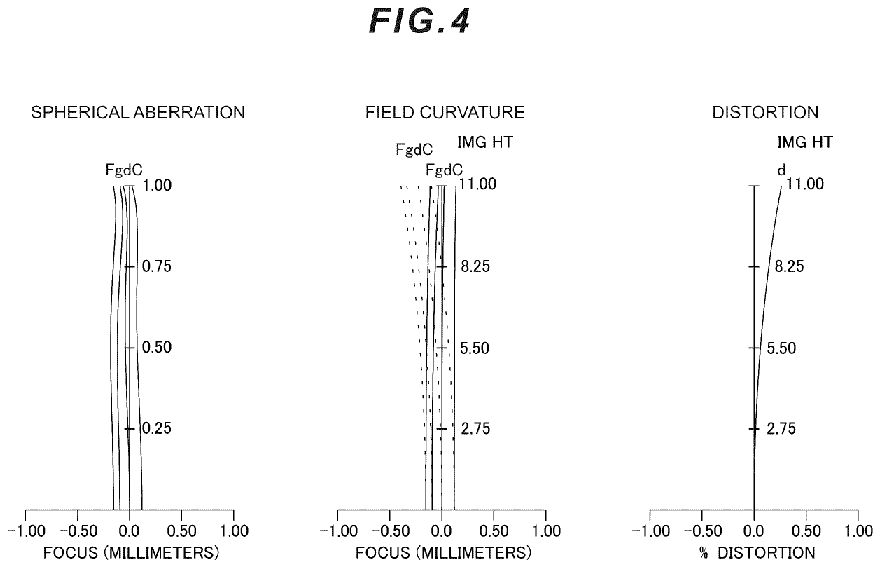

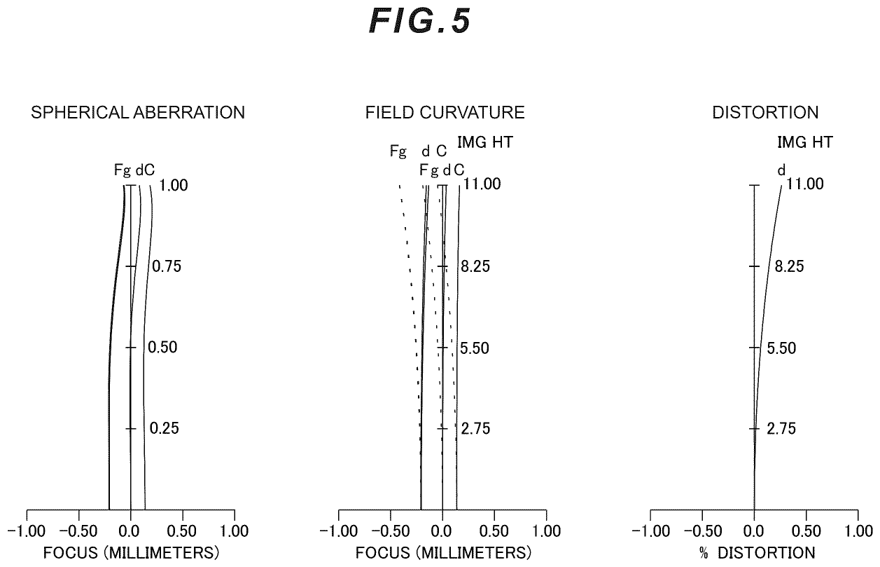

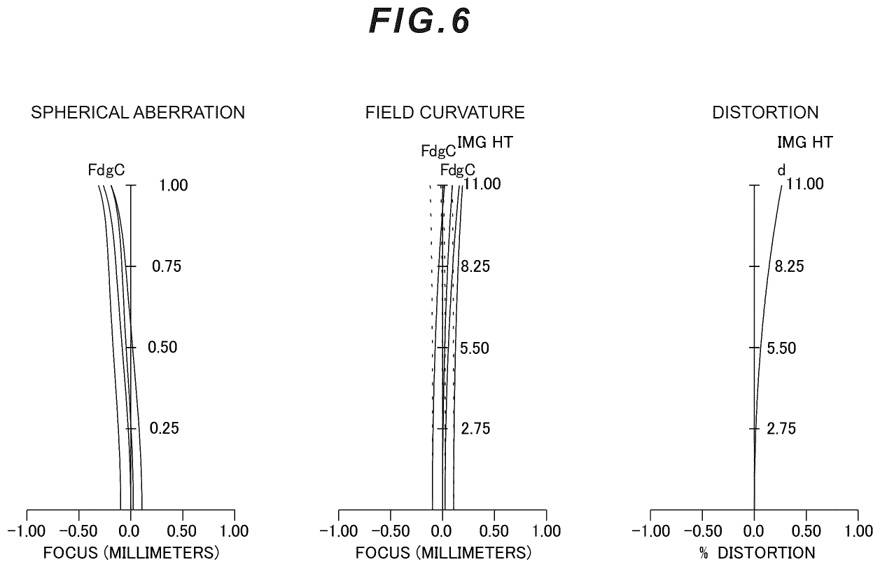

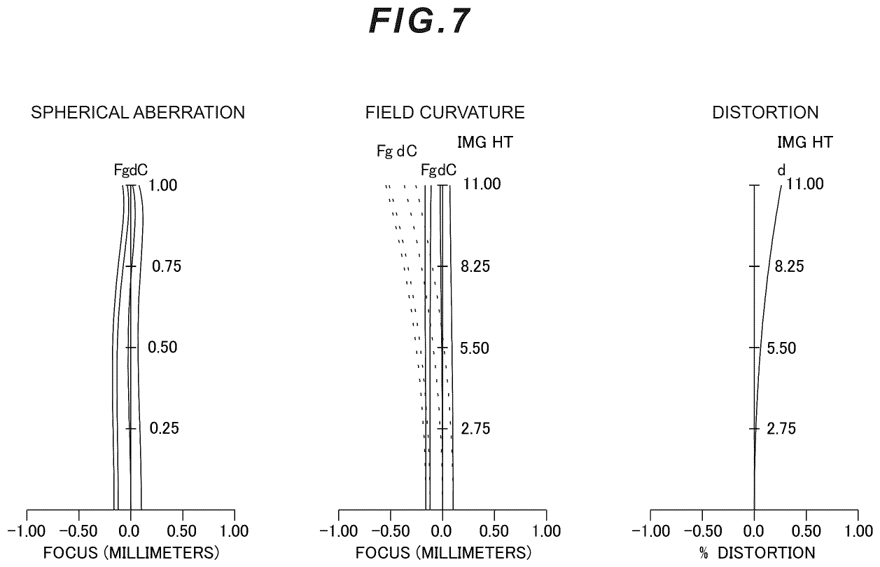

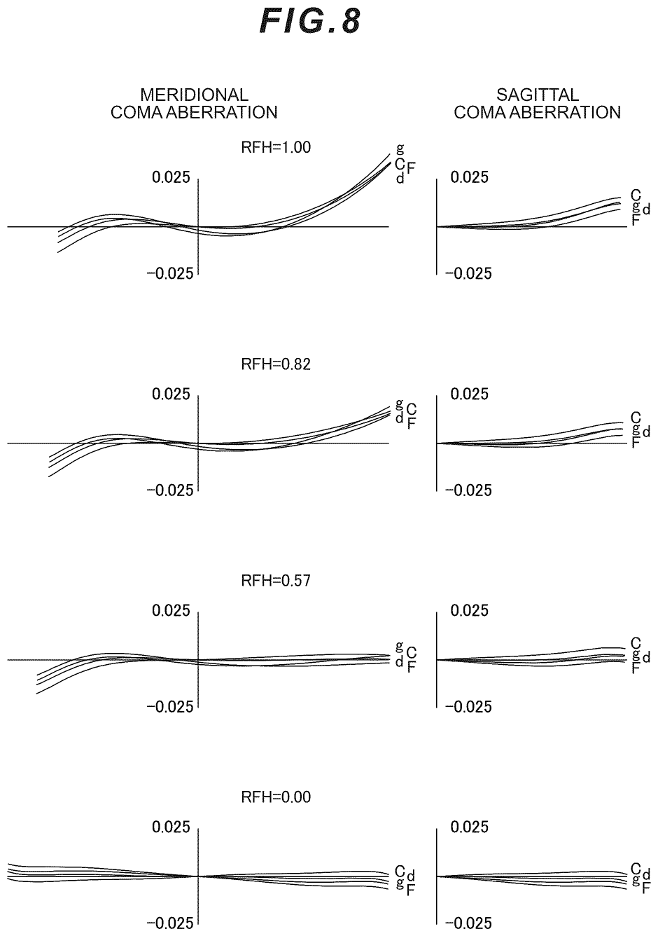

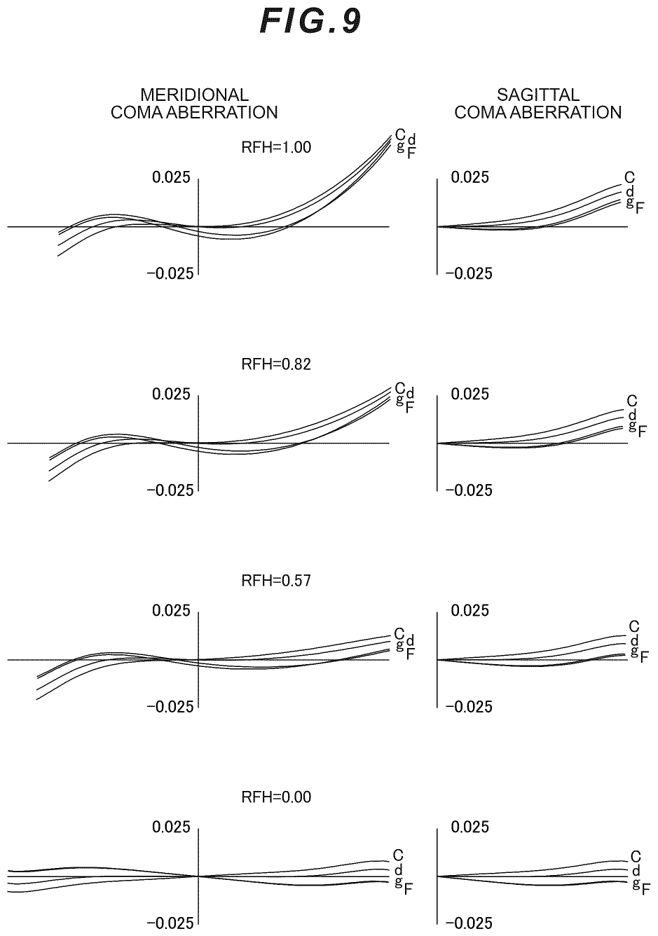

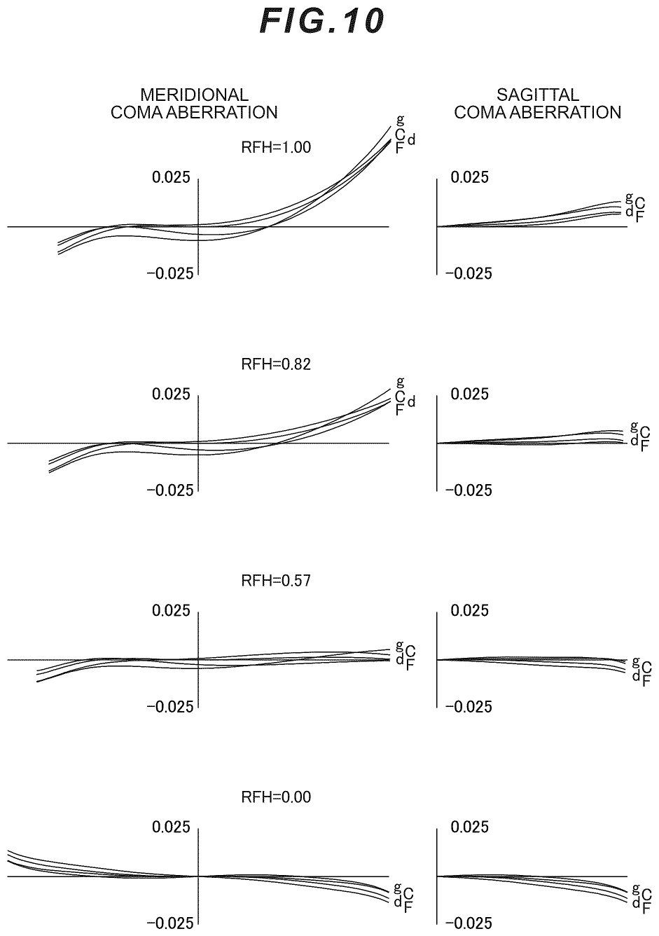

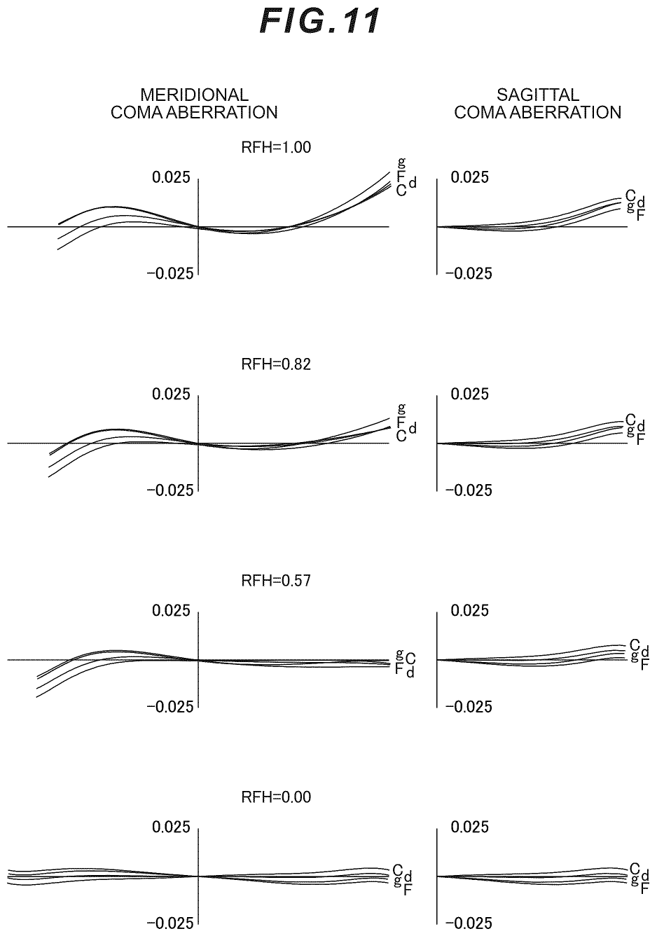

FIG. 4 is a graph showing various aberrations (spherical aberration, curvature of field, and distortion) of the attachment optical system according to Example 1 when silicone is used as the immersion liquid. FIG. 5 is a graph showing various aberrations of the attachment optical system according to Example 1 when glycerin is used as the immersion liquid. FIG. 6 is a graph showing various aberrations of the attachment optical system according to Example 1 when oil is used as the immersion liquid. FIG. 7 is a graph showing various aberrations of the attachment optical system according to Example 1 when water is used as the immersion liquid. FIG. 8 is a graph showing a coma aberration (meridional coma aberration and sagittal coma aberration) of the attachment optical system according to Example 1 when silicone is used as the immersion liquid. FIG. 9 is a graph showing a coma aberration of the attachment optical system according to Example 1 when glycerin is used as the immersion liquid. FIG. 10 is a graph showing a coma aberration of the attachment optical system according to Example 1 when oil is used as the immersion liquid. FIG. 11 is a graph showing a coma aberration of the attachment optical system according to Example 1 when water is used as the immersion liquid.

The aberration graphs indicate graphs showing various aberrations in a state where the objective lens and the image forming lens are combined with the attachment optical system. In each of the aberration graphs in FIGS. 4 to 11, d represents various aberrations relative to a d-line (wavelength λ=587.6 nm), C represents various aberrations relative to a C-line (wavelength λ=656.3 nm), F represents various aberrations relative to an F-line (wavelength \=486.1 nm), and g represents various aberrations relative to a g-line (wavelength λ=435.8 nm). In the spherical aberration graph, a vertical axis represents values obtained by normalizing a maximum value of the radius of the entrance pupil as 1, and a horizontal axis represents an aberration value [mm] for each ray. In the aberration graph showing the curvature of field, solid lines represent sagittal image surfaces corresponding to respective wavelengths, and dashed lines represent meridional image surfaces corresponding to the respective wavelengths. In the aberration graph showing the curvature of field, a vertical axis represents an image height [mm], and a horizontal axis represents an aberration value [mm]. In the distortion graph (distortion), a vertical axis represents an image height [mm], and a horizontal axis represents an aberration ratio by percentage (% value). Each of the coma aberration graphs shows aberration values when relative field height (RFH) that is an image height ratio is 0.00 and 1.00. In the aberration graph of each Example below, the same symbols as those used in this Example are used, and redundant description is omitted.

From each of the aberration graphs, it can be seen that the attachment optical system according to Example 1 has excellent image forming performance, with various aberrations being well corrected depending on the type of the immersion liquid.

### Example 2

Example 2 will be described with reference to FIGS. 12 to 20 and Table 2. FIG. 12 is a cross-sectional view showing a configuration of an attachment optical system and an objective lens according to Example 2. An attachment optical system AL(2) according to Example 2 is detachably mounted between an objective lens OL(2) and an image forming lens (not shown in FIG. 12) according to Example 2. The objective lens OL(2) according to Example 2 receives light from an object (sample SA) and converts the light into parallel light. The light (parallel light) from the objective lens OL(2) according to Example 2 is incident to the attachment optical system AL(2) according to Example 2. Air is filled between a tip of the objective lens OL(2) according to Example 2 and a cover glass CV that covers the object. Furthermore, an immersion liquid M is filled between the cover glass CV and the object. An example of the immersion liquid M includes, for example, silicone, glycerin, oil, or water.

The objective lens OL(2) according to Example 2 comprises first to eighth lenses L1 to L8. The first to eighth lenses L1 to L8 have the same configuration as the first to eighth lenses L1 to L8 of the objective lens OL(1) according to Example 1, and a detailed description thereof will not be given.

The attachment optical system AL(2) according to Example 2 comprises a cemented lens CL11 in which a biconcave negative lens L11 and a positive meniscus lens L12 having a convex surface facing the object are cemented, and a biconvex positive lens L13 which are disposed in order from the object (the objective lens OL(2)) on the optical axis. In Example 2, the cemented lens CL11 having negative refractive power is equivalent to the first optical element EL1 described above, and the positive lens L13 is equivalent to the second optical element EL2 described above. In addition, the correction collar 28 (see FIG. 2) is configured to be rotated around the optical axis depending on the type and depth of the immersion liquid M and the thickness of the cover glass CV, whereby the cemented lens CL11 can be moved along the optical axis.

In Example 2, the refractive index of the silicone to the d-line (wavelength λ=587.6 nm) is 1.4041. The refractive index of the glycerin to the d-line (wavelength λ=587.6 nm) is 1.4738. The refractive index of the oil to the d-line (wavelength λ=587.6 nm) is 1.5150. The refractive index of the water to the d-line (wavelength λ=587.6 nm) is 1.3326. The refractive index of the cover glass CV to the d-line (wavelength λ=587.6 nm) is 1.5244. A back-side focal position FP of the objective lens OL(2) according to Example 2 is located near an image (image forming lens) of the positive lens L13.

Table 2 below shows data values of the attachment optical system and the objective lens according to Example 2. Here, a first surface is an object surface, and a second surface and an eighteenth surface are virtual surfaces.

TABLE 2
General Data]

| | |
|---|---|
| NA = 0.200 | β = 4.857 |
| f = 2704.038 | φ = 16.470 |
| TLA = 6.987 | TLB = 32.00 |
| δA = 9.404 | |

[Lens Data]

| Surface | | | | |
|---|---|---|---|---|
| number | R | D | nd | νd |
| 1 | ∞ | (D1) | (ndM) | (νdM) |
| 2 | ∞ | 10.800 | (ndM) | (νdM) |
| 3 | ∞ | 2.000 | 1.5244 | 54.3 |
| 4 | ∞ | 19.000 | | |
| 5 | 81.180 | 2.762 | 1.804 | 46.6 |
| 6 | −28.510 | 0.200 | | |
| 7 | 19.709 | 6.427 | 1.5932 | 67.9 |
| 8 | −11.033 | 2.258 | 1.5481 | 45.8 |
| 9 | 12.498 | 4.417 | | |
| 10 | −7.790 | 1.000 | 1.738 | 32.3 |
| 11 | 42.222 | 6.661 | 1.4978 | 82.6 |
| 12 | −13.523 | 0.200 | | |
| 13 | −71.317 | 3.500 | 1.7408 | 27.7 |
| 14 | −15.666 | 0.200 | | |
| 15 | −23.138 | 1.000 | 1.6127 | 44.5 |
| 16 | 52.277 | 3.376 | 1.4978 | 82.6 |
| 17 | −29.535 | 0.200 | | |
| 18 | ∞ | (D18) | | |
| 19 | −146.966 | 1.016 | 1.6584 | 50.8 |
| 20 | 74.971 | 1.402 | 1.6180 | 63.3 |
| 21 | 92.777 | (D21) | | |
| 22 | 93.046 | 3.082 | 1.7340 | 51.5 |
| 23 | −188.384 | 100.000 | | |

[Variable distance data]

| | D1 | D18 | D21 | ndM | νdM |
|---|---|---|---|---|---|
| Silicone | 0.004 | 3.313 | 1.487 | 1.4041 | 52.0 |
| Glycerin | 0.507 | 3.215 | 1.584 | 1.4738 | 60.6 |
| Oil | 0.311 | 1.790 | 3.009 | 1.5150 | 43.1 |
| Water | −0.334 | 4.001 | 0.800 | 1.3326 | 55.9 |

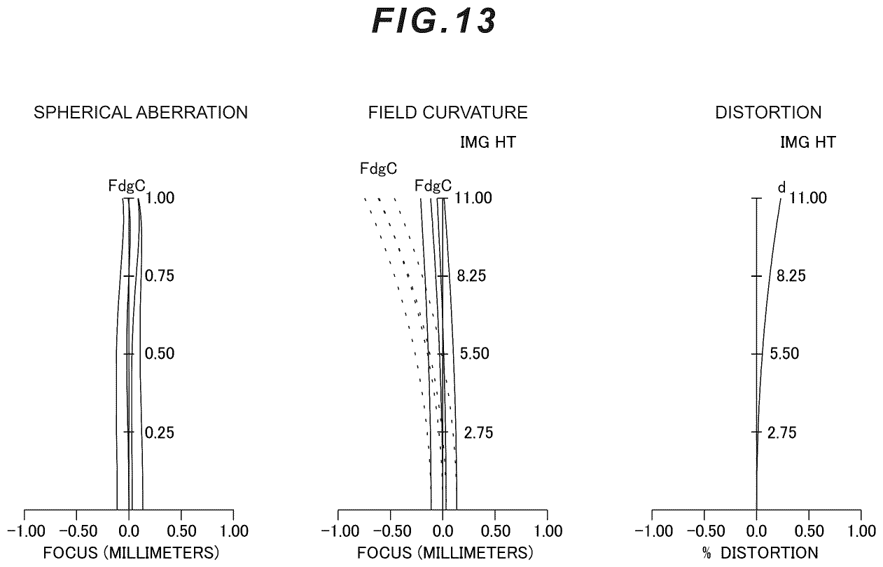

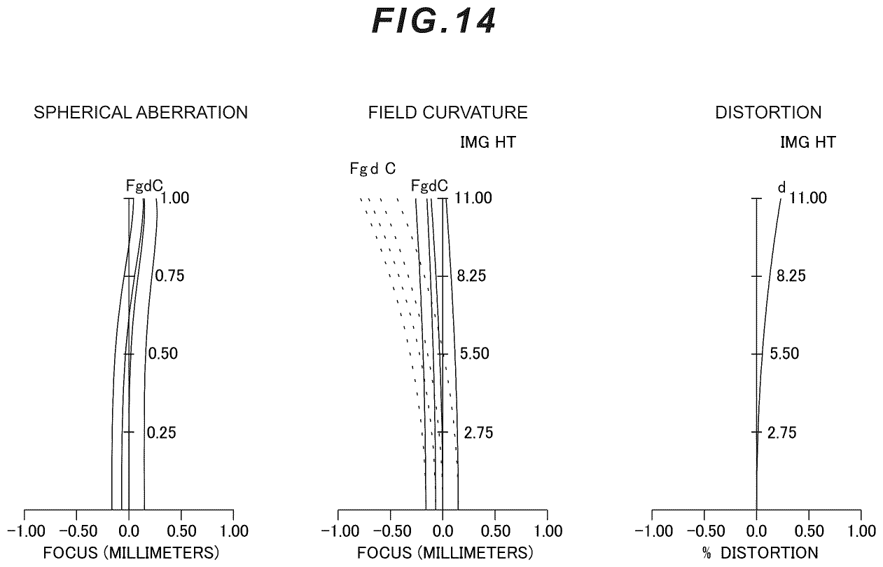

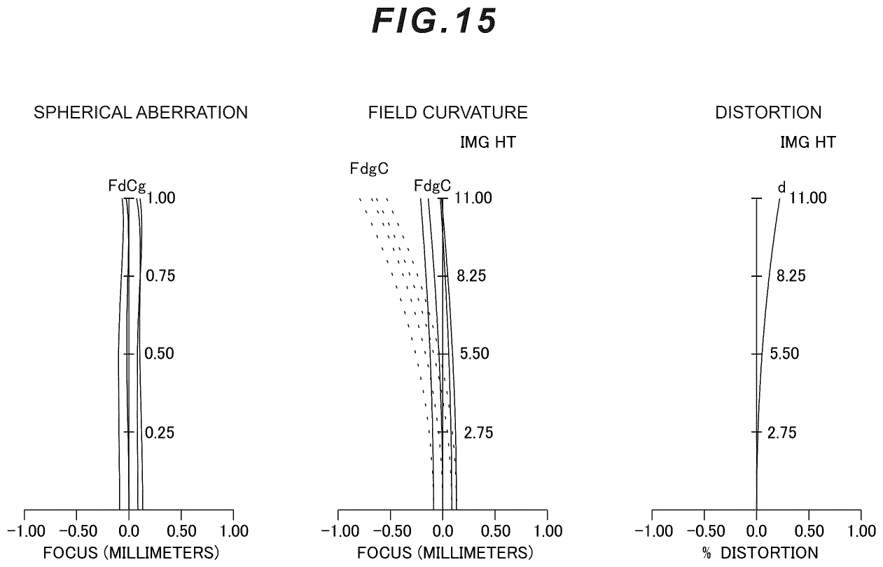

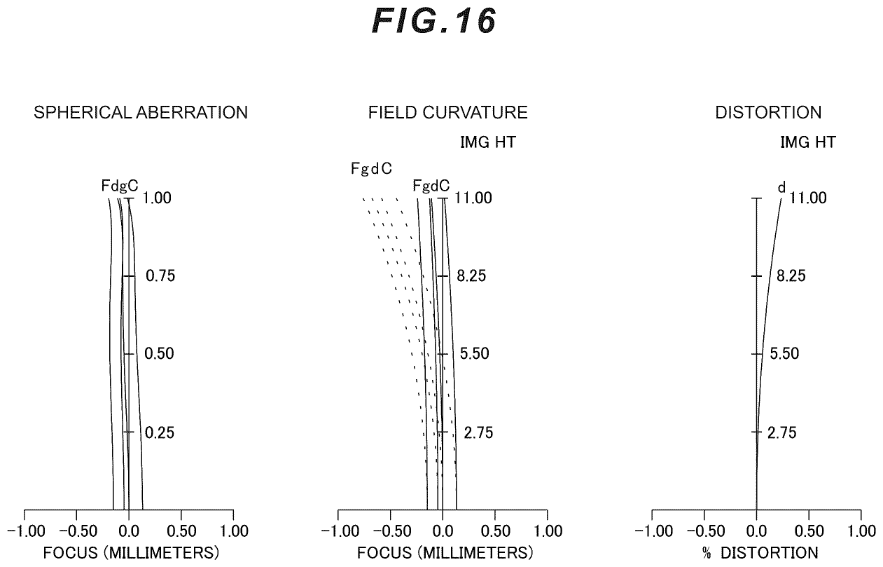

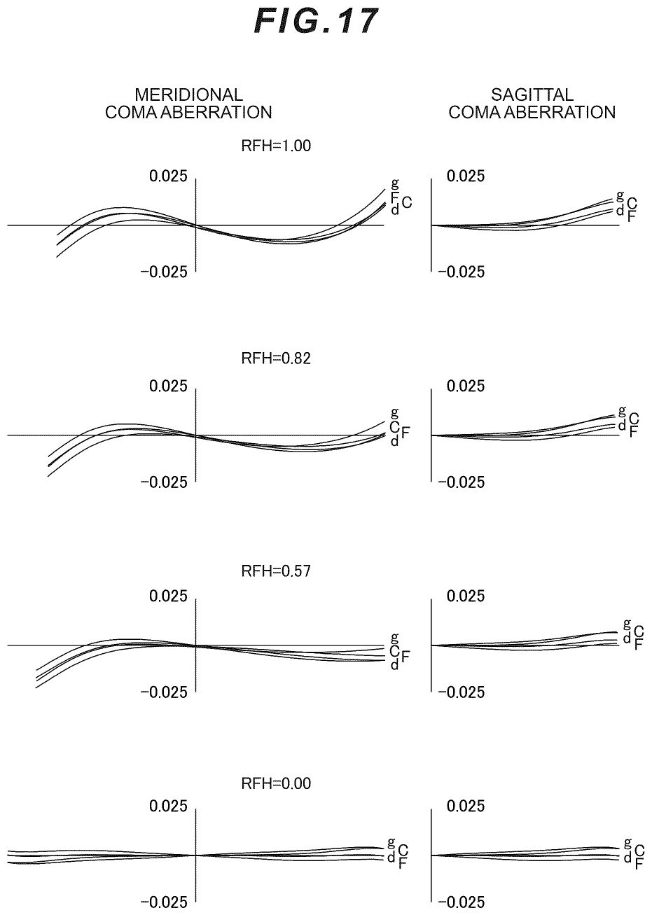

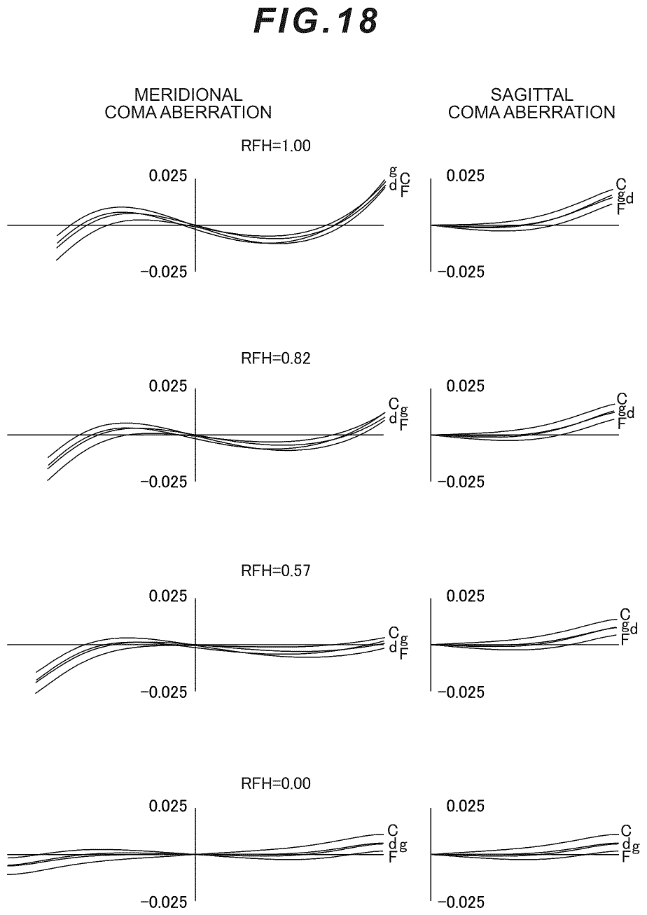

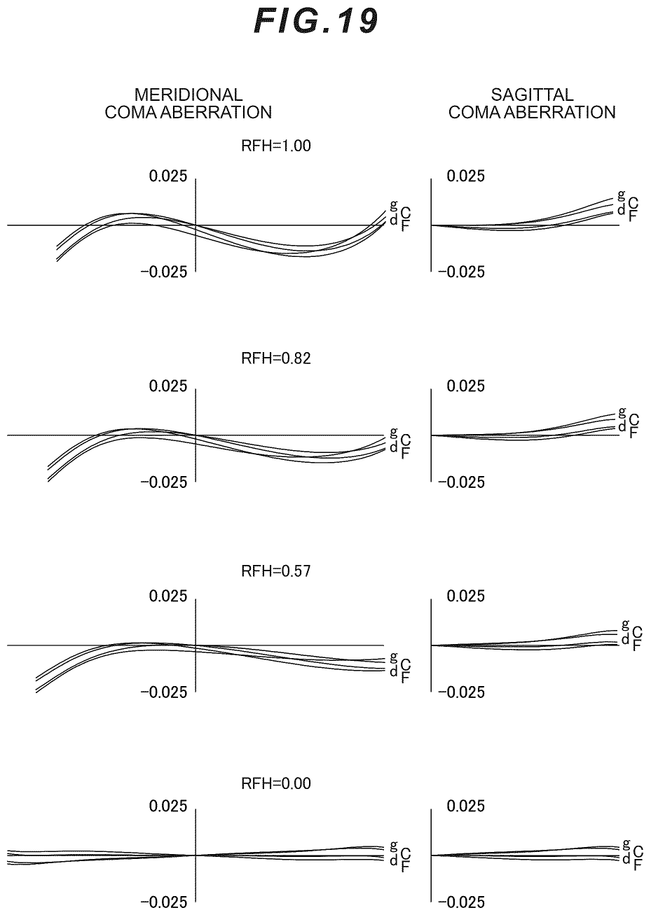

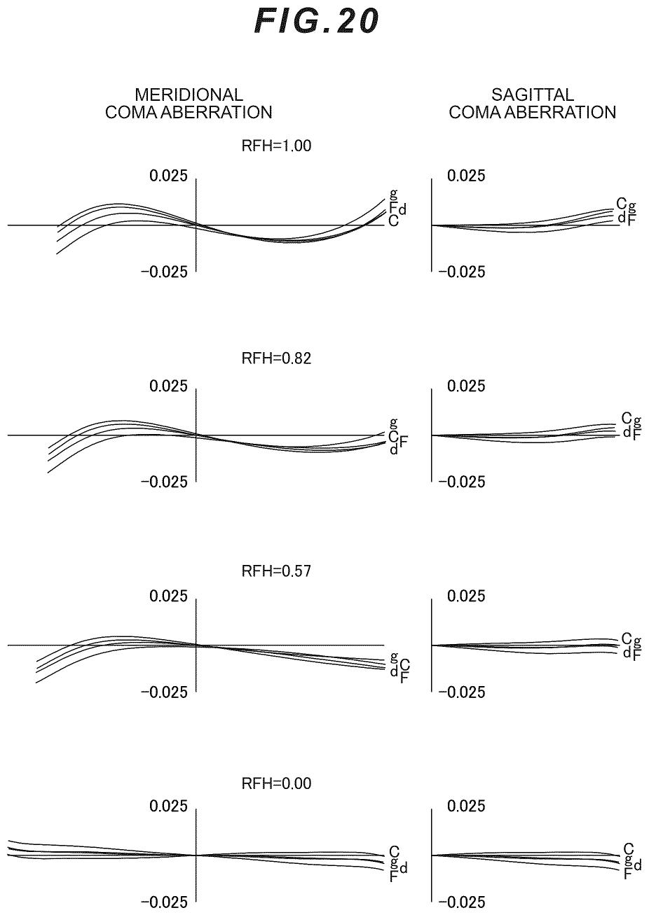

FIG. 13 is a graph showing various aberrations (spherical aberration, curvature of field, and distortion) of the attachment optical system according to Example 2 when silicone is used as the immersion liquid. FIG. 14 is a graph showing various aberrations of the attachment optical system according to Example 2 when glycerin is used as the immersion liquid. FIG. 15 is a graph showing various aberrations of the attachment optical system according to Example 2 when oil is used as the immersion liquid. FIG. 16 is a graph showing various aberrations of the attachment optical system according to Example 2 when water is used as the immersion liquid. FIG. 17 is a graph showing a coma aberration (meridional coma aberration and sagittal coma aberration) of the attachment optical system according to Example 2 when silicone is used as the immersion liquid. FIG. 18 is a graph showing a coma aberration of the attachment optical system according to Example 2 when glycerin is used as the immersion liquid. FIG. 19 is a graph showing a coma aberration of the attachment optical system according to Example 2 when oil is used as the immersion liquid. FIG. 20 is a graph showing a coma aberration of the attachment optical system according to Example 2 when water is used as the immersion liquid.

From each of the aberration graphs, it can be seen that the attachment optical system according to Example 2 has excellent image forming performance, with various aberrations being well corrected depending on the type of the immersion liquid.

### Example 3

Example 3 will be described with reference to FIGS. 21 to 27 and Table 3. FIG. 21 is a cross-sectional view showing a configuration of an attachment optical system and an objective lens according to Example 3. An attachment optical system AL(3) according to Example 3 is detachably mounted between an objective lens OL(3) and an image forming lens (not shown in FIG. 21) according to Example 3. The objective lens OL(3) according to Example 3 receives light from an object (sample SA) and converts the light into parallel light. The light (parallel light) from the objective lens OL(3) according to Example 3 is incident to the attachment optical system AL(3) according to Example 3. Air is filled between a tip of the objective lens OL(3) according to Example 3 and a cover glass CV that covers the object. Furthermore, an immersion liquid M is filled between the cover glass CV and the object. The immersion liquid M is water.

The objective lens OL(3) according to Example 3 comprises first to eighth lenses L1 to L8 which are disposed in order from the object on an optical axis. The first lens L1, the second lens L2, the fifth lens L5, and the eighth lens L8 are biconvex positive lenses. The third lens L3, the fourth lens L4, and the seventh lens L7 are biconcave negative lenses. The sixth lens L6 is a positive meniscus lens having a concave surface facing the object. The second lens L2 and the third lens L3 are cemented. The fourth lens L4 and the fifth lens L5 are cemented.

The attachment optical system AL(3) according to Example 3 has the same configuration of the attachment optical system AL(2) according to Example 2, and a detailed description thereof will not be given. In Example 3, a cemented lens CL11 having negative refractive power is equivalent to the first optical element EL1 described above, and the positive lens L13 is equivalent to the second optical element EL2 described above. In addition, the correction collar 28 (see FIG. 2) is rotated around the optical axis depending on the depth of the immersion liquid M, whereby the cemented lens CL11 is moved along the optical axis. Specifically, when the depth of the immersion liquid M becomes deeper, the correction collar 28 is rotated around the optical axis, whereby the cemented lens CL11 is moved toward the object (the objective lens OL(3)) along the optical axis.

In Example 3, the refractive index of the water to the d-line (wavelength λ=587.6 nm) is 1.3326. The refractive index of the cover glass CV to the d-line (wavelength λ=587.6 nm) is 1.5244. A back-side focal position FP of the objective lens OL(3) according to Example 3 is located near an image (image forming lens) of the positive lens L13.

Table 3 below shows data values of the attachment optical system and the objective lens according to Example 3. Here, a first surface is an object surface, and an eighteenth surface is a virtual surface.

TABLE 3
[General Data]

| | |
|---|---|
| NA = 0.200 | β = 3.911 |
| f = 3140.5 | φ = 20.455 |
| TLA = 6.614 | TLB = 33.86 |
| δA = 17.251 | |

[Lens Data]

| Surface | | | | |
|---|---|---|---|---|
| number | R | D | nd | νd |
| 1 | ∞ | (D1) | 1.3326 | 55.9 |
| 2 | ∞ | 1.000 | 1.5244 | 54.3 |
| 3 | ∞ | (D3) | | |
| 4 | 3353.400 | 2.701 | 1.8040 | 46.6 |
| 5 | −20.954 | 2.252 | | |
| 6 | 17.610 | 4.043 | 1.6030 | 65.4 |
| 7 | −145.072 | 1.000 | 1.5481 | 45.5 |
| 8 | 12.312 | 4.848 | | |
| 9 | −7.474 | 2.119 | 1.7380 | 32.3 |
| 10 | 37.508 | 5.134 | 1.4978 | 82.6 |
| 11 | −12.221 | 0.200 | | |
| 12 | −37.834 | 3.969 | 1.7408 | 27.7 |
| 13 | −13.138 | 0.401 | | |
| 14 | −15.898 | 1.000 | 1.6127 | 44.5 |
| 15 | 53.834 | 1.001 | | |
| 16 | 57.265 | 5.189 | 1.4978 | 82.6 |
| 17 | −20.426 | 2.000 | | |
| 18 | ∞ | (D18) | | |
| 19 | −146.966 | 1.016 | 1.6584 | 50.8 |
| 20 | 74.971 | 1.402 | 1.6180 | 63.3 |
| 21 | 92.777 | (D21) | | |
| 22 | 93.046 | 3.082 | 1.7340 | 51.5 |
| 23 | −188.384 | 100.000 | | |

[Variable distance data]

| | D1 | D3 | D18 | D21 |
|---|---|---|---|---|
| Water depth 0.5 mm | 0.500 | 28.500 | 7.386 | 1.114 |
| Water depth 2.5 mm | 2.500 | 26.500 | 6.015 | 2.484 |
| Water depth 3.5 mm | 3.500 | 25.500 | 5.342 | 3.158 |

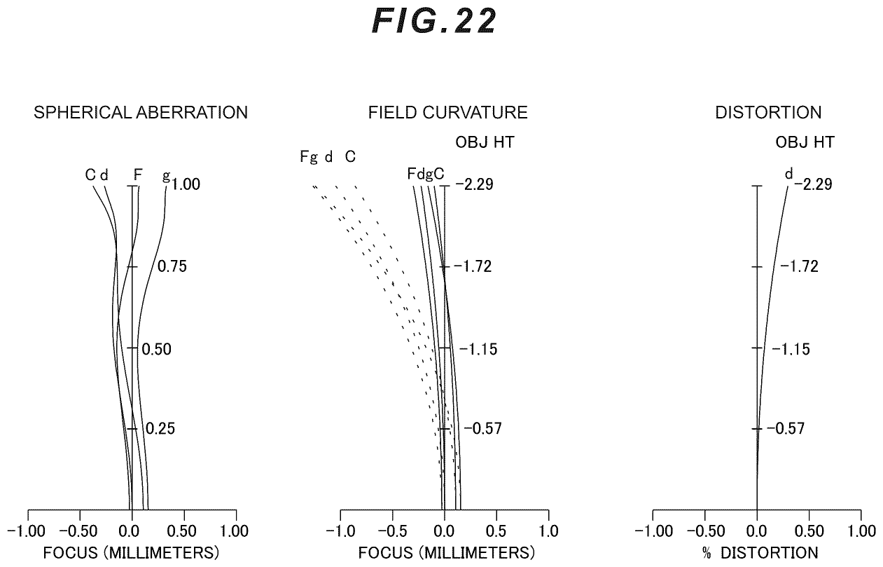

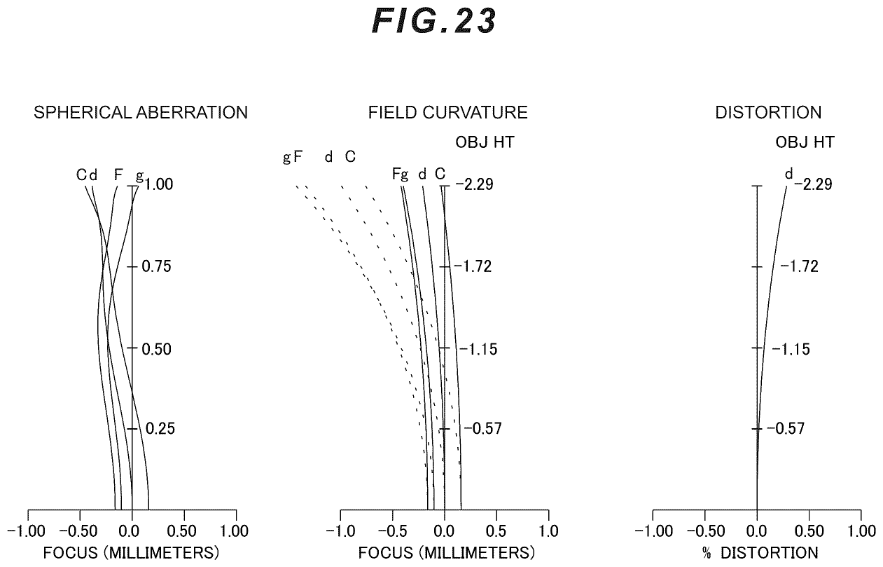

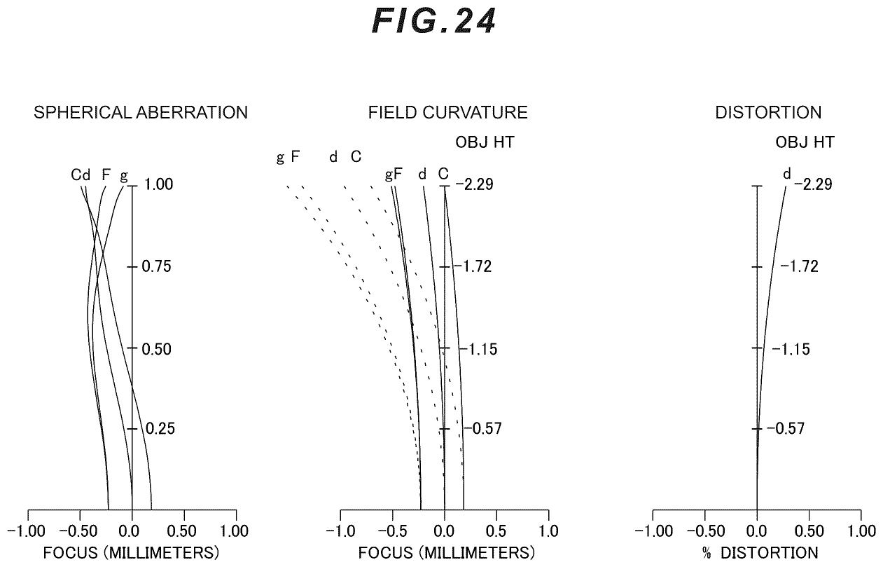

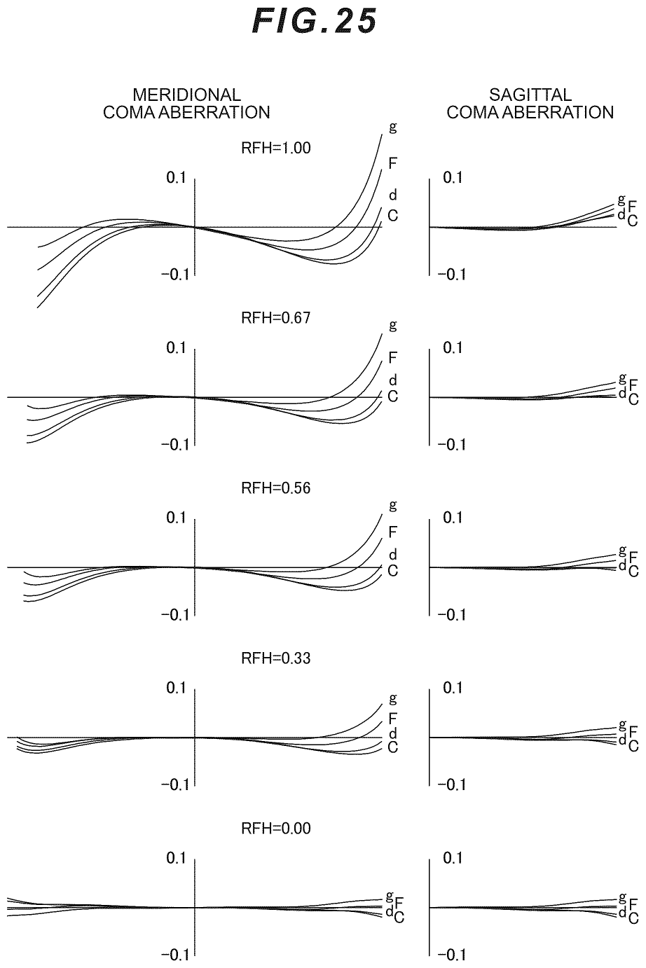

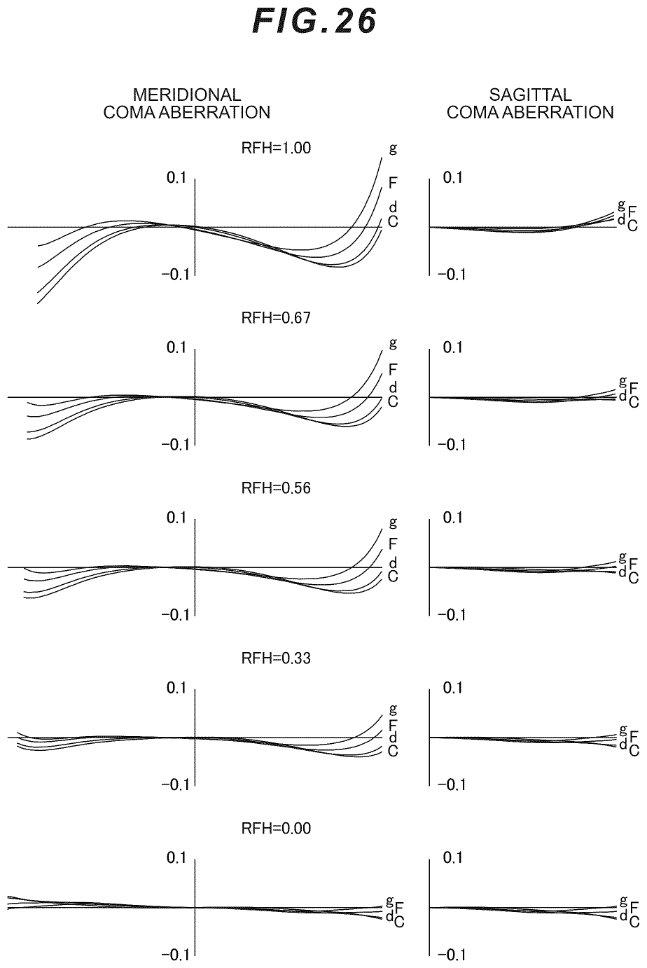

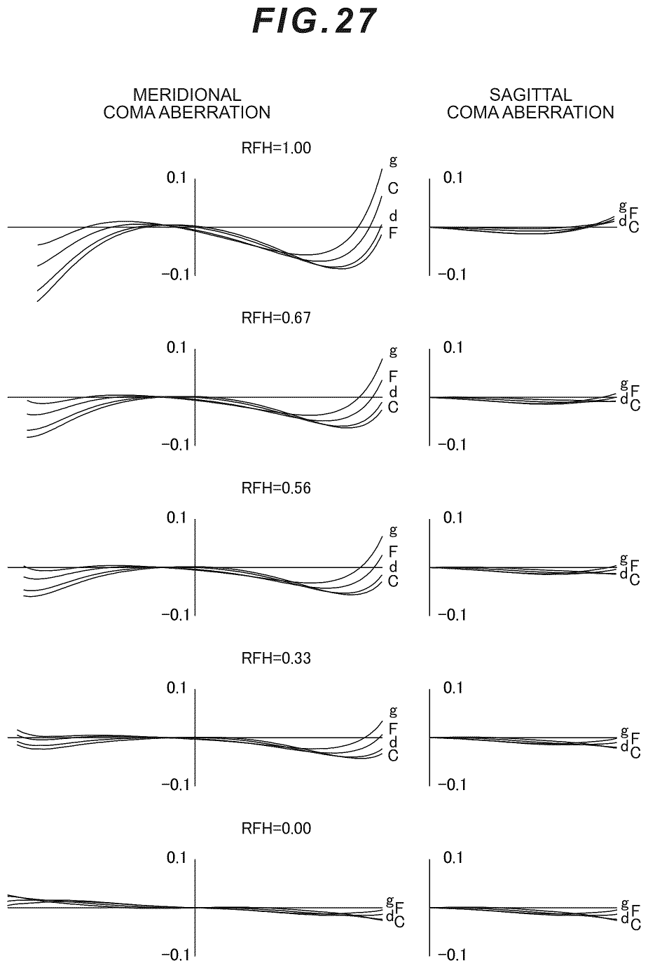

FIG. 22 is a graph showing various aberrations (spherical aberration, curvature of field, and distortion) of the attachment optical system according to Example 3 when an object is observed at a water depth of 0.5 mm. FIG. 23 is a graph showing various aberrations of the attachment optical system according to Example 3 when an object is observed at a water depth of 2.5 mm. FIG. 24 is a graph showing various aberrations of the attachment optical system according to Example 3 when an object is observed at a water depth of 3.5 mm. FIG. 25 is a graph showing a coma aberration (meridional coma aberration and sagittal coma aberration) of the attachment optical system according to Example 3 when an object is observed at a water depth of 0.5 mm. FIG. 26 is a graph showing a coma aberration of the attachment optical system according to Example 3 when an object is observed at a water depth of 2.5 mm. FIG. 27 is a graph showing a coma aberration of the attachment optical system according to Example 3 when an object is observed at a water depth of 3.5 mm.

In Example 3, in the aberration graph showing the curvature of field, a vertical axis represents an object height [mm], and a horizontal axis represents an aberration value [mm]. In the distortion graph (distortion), a vertical axis represents an object height [mm], and a horizontal axis represents an aberration ratio by percentage (% value). From each of the aberration graphs, it can be seen that the attachment optical system according to Example 3 has excellent image forming performance, with various aberrations being well corrected depending on the depth of the immersion liquid.

### Example 4

Example 4 will be described with reference to FIGS. 28 to 36 and Table 4. FIG. 28 is a cross-sectional view showing a configuration of an attachment optical system and an objective lens according to Example 4. An attachment optical system AL(4) according to Example 4 is detachably mounted between an objective lens OL(4) and an image forming lens (not shown in FIG. 28) according to Example 4. The objective lens OL(4) according to Example 4 receives light from an object (sample SA) and converts the light into parallel light. The light (parallel light) from the objective lens OL(4) according to Example 4 is incident to the attachment optical system AL(4) according to Example 4. Air is filled between a tip of the objective lens OL(4) according to Example 4 and a cover glass CV that covers the object. Furthermore, an immersion liquid M is filled between the cover glass CV and the object. An example of the immersion liquid M includes, for example, silicone, glycerin, oil, or water.

The objective lens OL(4) according to Example 4 comprises first to eighth lenses L1 to L8. The first to eighth lenses L1 to L8 have the same configuration as the first to eighth lenses L1 to L8 of the objective lens OL(1) according to Example 1, and a detailed description will not be given.

The attachment optical system AL(4) according to Example 4 comprises a diffractive optical element DL1 having positive refractive power and a diffractive optical element DL2 having negative refractive power which are disposed in order from the object (the objective lens OL(4)) on the optical axis. In Example 4, the diffractive optical element DL2 having negative refractive power is equivalent to the first optical element EL1 described above, and the diffractive optical element DL1 having positive refractive power is equivalent to the second optical element EL2 described above. In addition, the correction collar 28 (see FIG. 2) is configured to be rotated around the optical axis depending on the type and depth of the immersion liquid M and the thickness of the cover glass CV, whereby the diffractive optical element DL1 having positive refractive power can be moved along the optical axis.

The diffractive optical element DL1 having positive refractive power includes a first parallel flat plate PP1, a first optical element component DE1 cemented to the first parallel flat plate PP1, a second optical element component DE2 cemented to the first optical element component DE1, and a second parallel flat plate PP2 cemented to the second optical element component DE2 which are disposed in order from the object (the objective lens OL(4)) on the optical axis. The first optical element component DE1 and the second optical element component DE2 have different refractive indices. An annular diffractive optical surface (not shown) constituting a diffraction grating is formed at an interface between the first optical element component DE1 and the second optical element component DE2. In this way, the diffractive optical element DL1 having positive refractive power is a dual-contact diffractive optical element.

The diffractive optical element DL2 having negative refractive power includes a third parallel flat plate PP3, a third optical element component DE3 cemented to the third parallel flat plate PP3, a fourth optical element component DE4 cemented to the third optical element component DE3, and a fourth parallel flat plate PP4 cemented to the fourth optical element component DE4 which are disposed in order from the object (the objective lens OL(4)) on the optical axis. The third optical element component DE3 and the fourth optical element component DE4 have different refractive indices. An annular diffractive optical surface (not shown) constituting a diffraction grating is formed at an interface between the third optical element component DE3 and the fourth optical element component DE4. In this way, the diffractive optical element DL2 having negative refractive power is also a dual-contact diffractive optical element.

In Example 4, the refractive index of the silicone to the d-line (wavelength λ=587.6 nm) is 1.4041. The refractive index of the glycerin to the d-line (wavelength \=587.6 nm) is 1.4738. The refractive index of the oil to the d-line (wavelength λ=587.6 nm) is 1.5150. The refractive index of the water to the d-line (wavelength λ=587.6 nm) is 1.3326. The refractive index of the cover glass CV to the d-line (wavelength λ=587.6 nm) is 1.5244. In addition, a back-side focal position FP of the objective lens OL(4) according to Example 4 is located between the diffractive optical element DL1 having positive refractive power and the diffractive optical element DL2 having negative refractive power.

Table 4 below shows data values of the attachment optical system and the objective lens according to Example 4. Here, a first surface is an object surface, and a second surface is a virtual surface. Furthermore, a 20th and a 25th surface are diffractive optical surfaces.

TABLE 4
[General Data]

| | |
|---|---|
| NA = 0.200 | β = 5.016 |
| f = −39566.881 | φ = 16.746 |
| TLA = 14.900 | TLB = 32.00 |
| δA = 9.731 | |

[Lens Data]

| Surface | | | | |
|---|---|---|---|---|
| number | R | D | nd | νd |
| 1 | ∞ | (D1) | (ndM) | (νdM) |
| 2 | ∞ | 1.870 | (ndM) | (νdM) |
| 3 | ∞ | 2.000 | 1.5244 | 54.3 |
| 4 | ∞ | (D4) | | |
| 5 | 81.180 | 2.762 | 1.8040 | 46.6 |
| 6 | −28.510 | 0.200 | | |
| 7 | 19.709 | 6.427 | 1.5932 | 67.9 |
| 8 | −11.033 | 2.258 | 1.5481 | 45.8 |
| 9 | 12.498 | 4.417 | | |
| 10 | −7.790 | 1.000 | 1.738 | 32.3 |
| 11 | 42.222 | 6.661 | 1.4978 | 82.6 |
| 12 | −13.523 | 0.200 | | |
| 13 | −71.317 | 3.500 | 1.7408 | 27.7 |
| 14 | −15.666 | 0.200 | | |
| 15 | −23.138 | 1.000 | 1.6127 | 44.5 |
| 16 | 52.277 | 3.376 | 1.4978 | 82.6 |
| 17 | −29.535 | (D17) | | |
| 18 | ∞ | 1.000 | 1.5168 | 64.1 |
| 19 | ∞ | 0.100 | 1.5571 | 49.7 |
| 20* | ∞ | 0.100 | 1.5278 | 33.4 |
| 21 | ∞ | 1.000 | 1.5168 | 64.1 |
| 22 | ∞ | (D22) | | |
| 23 | ∞ | 1.000 | 1.5168 | 64.1 |
| 24 | ∞ | 0.100 | 1.5571 | 49.7 |
| 25* | ∞ | 0.100 | 1.5278 | 33.4 |
| 26 | ∞ | 1.000 | 1.5168 | 64.1 |
| 27 | ∞ | 100.000 | | |

[Coefficient Surface Data]
20th Surface
Order of Diffraction= −1

| | Coefficient of |
|---|---|
| Term | 20th Surface |
| C2 | 1.0513E−04 |
| C4 | 4.1567E−07 |
| C6 | −2.7587E−09 |

25th Surface
Order of Diffraction= −1

| | Coefficient of |
|---|---|
| Term | 25th Surface |
| C2 | −1.1806E−04 |
| C4 | −3.6187E−07 |
| C6 | 2.4757E−09 |

[Variable distance data]

| | D1 | D4 | D17 | D22 | ndM | νdM |
|---|---|---|---|---|---|---|
| Silicone | 0.790 | 17.070 | 2.400 | 10.600 | 1.4041 | 52.0 |
| Glycerin | 1.290 | 17.130 | 2.680 | 10.320 | 1.4738 | 60.6 |
| Oil | −2.070 | 19.570 | 2.670 | 10.330 | 1.5150 | 43.1 |
| Water | 1.870 | 15.820 | 2.500 | 10.500 | 1.3326 | 55.9 |

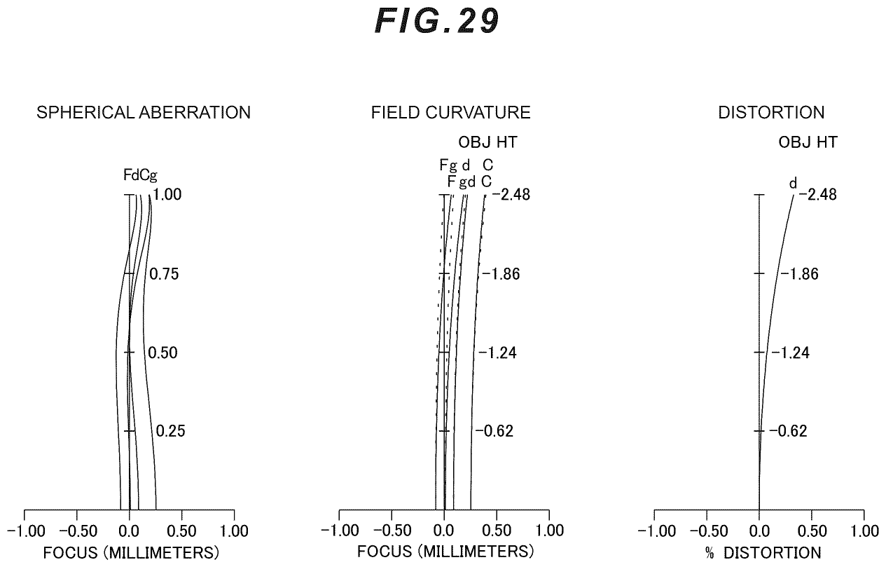

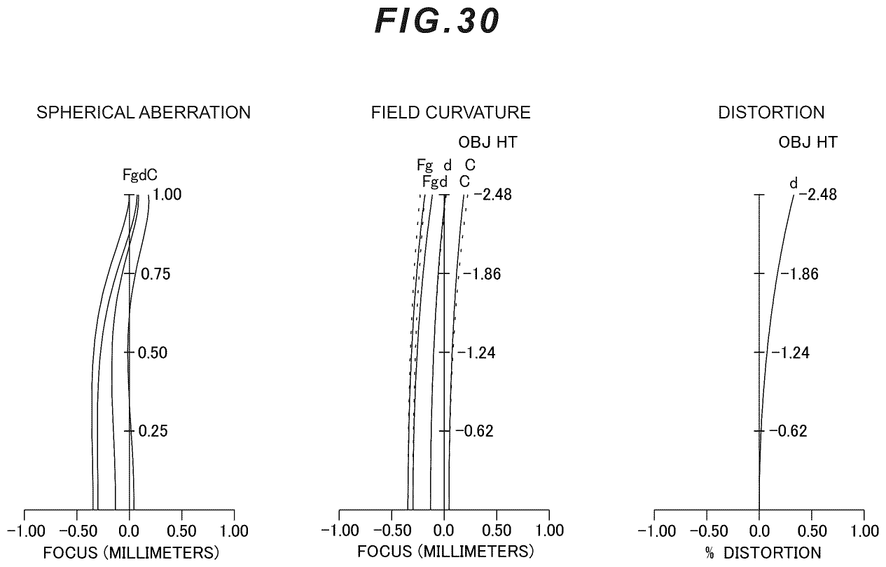

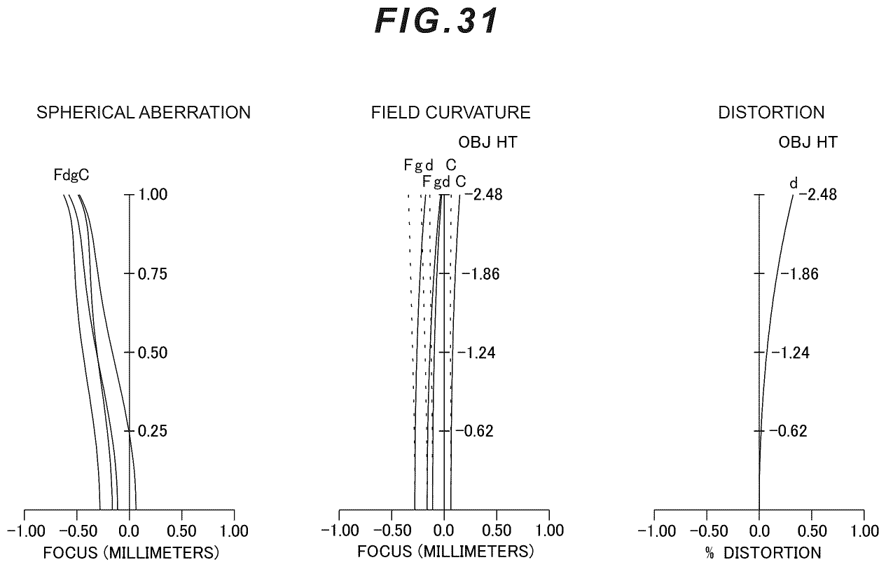

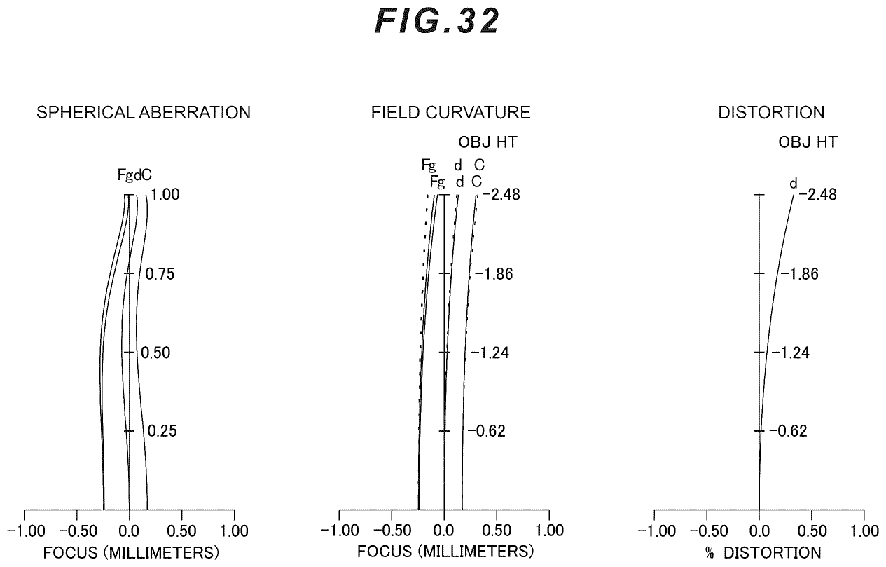

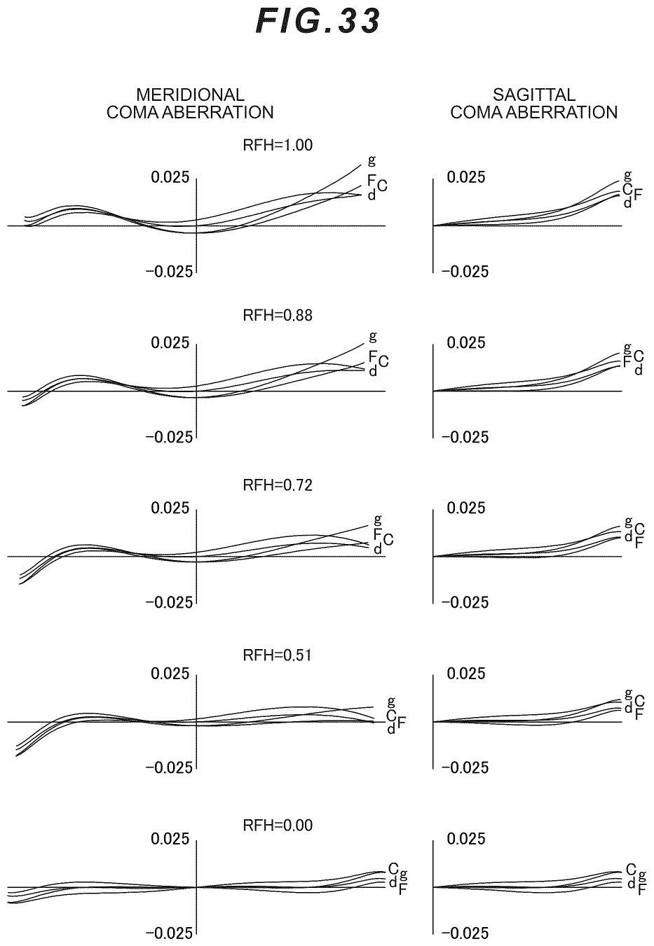

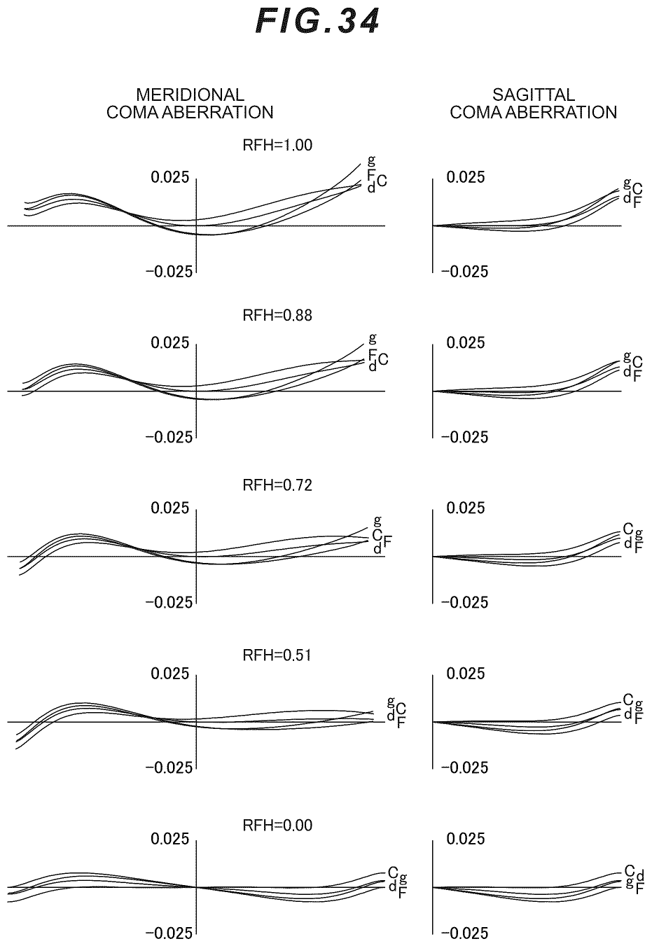

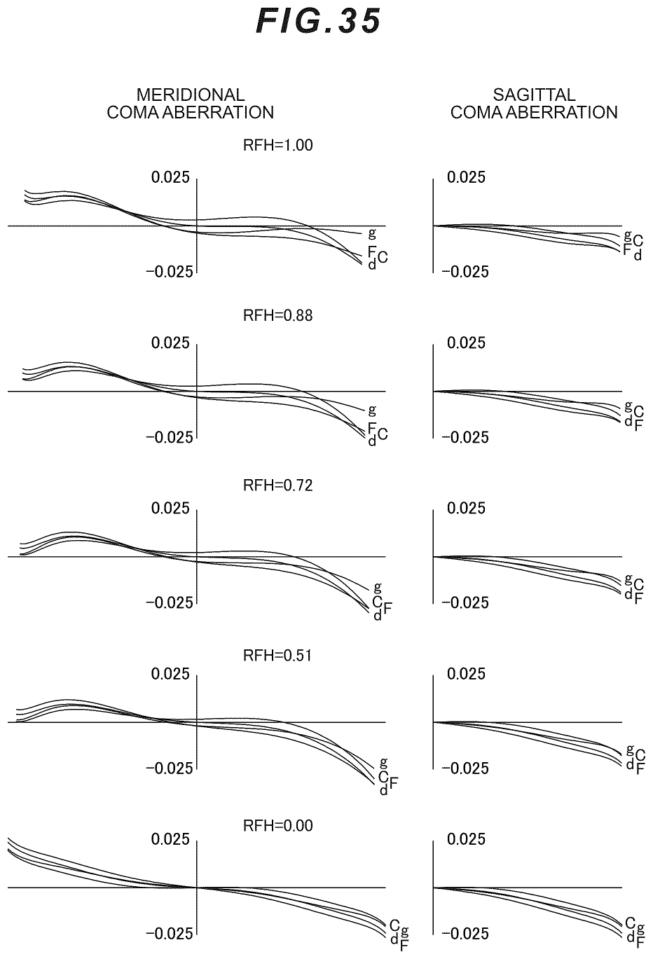

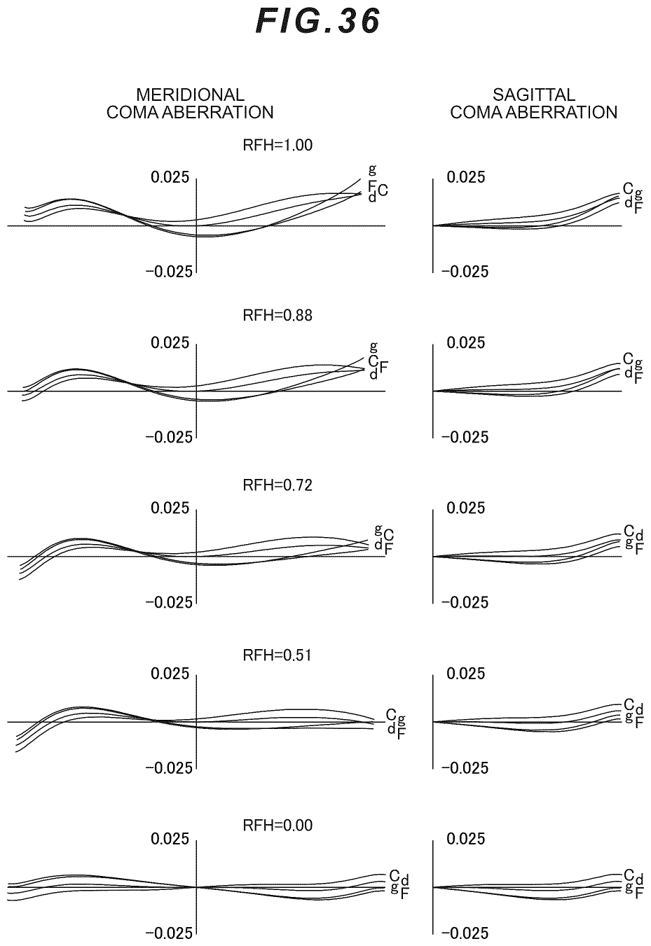

FIG. 29 is a graph showing various aberrations (spherical aberration, curvature of field, and distortion) of the attachment optical system according to Example 4 when silicone is used as the immersion liquid. FIG. 30 is a graph showing various aberrations of the attachment optical system according to Example 4 when glycerin is used as the immersion liquid. FIG. 31 is a graph showing various aberrations of the attachment optical system according to Example 4 when oil is used as the immersion liquid. FIG. 32 is a graph showing various aberrations of the attachment optical system according to Example 4 when water is used as the immersion liquid. FIG. 33 is a graph showing a coma aberration (meridional coma aberration and sagittal coma aberration) of the attachment optical system according to Example 4 when silicone is used as the immersion liquid. FIG. 34 is a graph showing a coma aberration of the attachment optical system according to Example 4 when glycerin is used as the immersion liquid. FIG. 35 is a graph showing a coma aberration of the attachment optical system according to Example 4 when oil is used as the immersion liquid. FIG. 36 is a graph showing a coma aberration of the attachment optical system according to Example 4 when water is used as the immersion liquid.

In Example 4, in the aberration graph showing the curvature of field, a vertical axis represents an object height [mm], and a horizontal axis represents an aberration value [mm]. In the distortion graph (distortion), a vertical axis represents an object height [mm], and a horizontal axis represents an aberration ratio by percentage (% value). From each of the aberration graphs, it can be seen that the attachment optical system according to Example 4 has excellent image forming performance, with various aberrations being well corrected depending on the type of the immersion liquid.

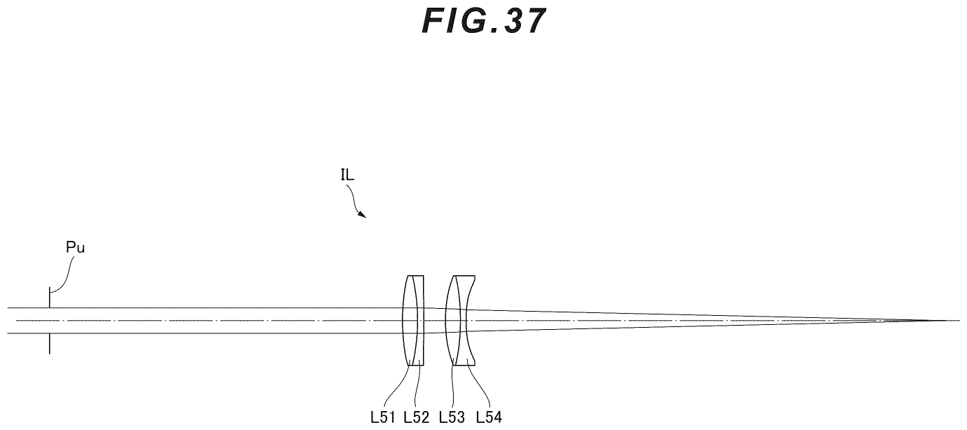

The objective lens according to each of Examples is an infinity-corrected lens. For this reason, the attachment optical system according to each of Examples is used in combination with an image forming lens that forms an image from the light from the objective lens. Here, an example of an image forming lens used in combination with the attachment optical system will be described with reference to FIG. 37 and Table 5. FIG. 37 is a cross-sectional view showing a configuration of the image forming lens used in combination with the attachment optical system according to each of Examples. The graphs showing various aberrations in the attachment optical system according to each of Examples are obtained in a case of being used in combination with the objective lens according to each of Examples and the image forming lens. An image forming lens IL shown in FIG. 37 comprises a cemented lens in which a biconvex positive lens L51 and a biconcave negative lens L52 are cemented, and a cemented lens in which a biconvex positive lens L53 and a biconcave negative lens L54 are cemented which are disposed in order from the object. The image forming lens IL is disposed on the image side of the objective lens according to each of Examples. FIG. 37 shows an entrance pupil surface Pu of the image forming lens IL.

Table 5 below shows data values of the image forming lens. In the table of [General Data], a symbol f′ represents a focal length of the image forming lens. In the table of [Lens Data], a surface number and symbols R, D, nd, and νd are the same as those indicated in Tables 1 to 4.

TABLE 5

[General Data]
f′ = 200

[Lens Data]

| Surface | | | | |
|---|---|---|---|---|
| number | R | D | nd | νd |
| 1 | 75.043 | 5.100 | 1.6228 | 57.03 |
| 2 | −75.043 | 2.000 | 1.7495 | 35.19 |
| 3 | 1600.58 | 7.500 | | |
| 4 | 50.256 | 5.100 | 1.6676 | 41.96 |
| 5 | −84.541 | 1.800 | 1.6127 | 44.40 |
| 6 | 36.911 | 168.438 | | |

Next, a table of [Conditional Expression Corresponding Value] is shown below. In the table, values corresponding to each of conditional expressions (1) to (5) are summarized for all Examples (Examples 1 to 4).

Conditional expression (1) 2 < |fA|/TLA < 10000
Conditional expression (2) 35 < νdP < 101
Conditional expression (3) 0 ≤ νdP − νdN < 30
Conditional expression (4) 0.1 < δA/TLA < 4.5
Conditional expression (5) 0.05 < TLA/TLB < 0.75

### [Conditional Expression Corresponding Value] (Examples 1 to 4)

| Conditional | | | | |
|---|---|---|---|---|
| expression | Example 1 | Example 2 | Example 3 | Example 4 |
| (1) | 1197.993 | 386.994 | 474.851 | 2655.495 |
| (2) | 64.1 | 51.5 | 51.5 | — |
| (3) | 0.0 | 0.7 | 0.7 | — |
| (4) | 1.209 | 1.346 | 2.608 | 0.653 |
| (5) | 0.183 | 0.218 | 0.195 | 0.466 |

According to each of Examples described above, it is possible to achieve the attachment optical system capable of correcting the longitudinal chromatic aberration and the spherical aberration that occur depending on the type of the immersion liquid.

Here, each of Examples described above indicates a specific example of the present embodiment, and the present embodiment is not limited to these Examples.

In Examples 1 to 3 described above, the second optical element EL2 is one positive lens, but is not limited thereto. For example, the second optical element EL2 may be a cemented lens, in which a positive lens and a negative lens are cemented, having positive refractive power, or may be one cemented lens having at least a positive lens.

In Example 1 described above, the negative lens L11 is configured to be movable along the optical axis, but is not limited thereto. For example, the positive lens L12 may be configured to be movable along the optical axis, and each of the negative lens L11 and the positive lens L12 may be configured to be movable along the optical axis. The negative lens L11 may be configured to be movable in a direction perpendicular to the optical axis without being limited to the direction along the optical axis. In addition, the positive lens L12 may be configured to be movable in a direction perpendicular to the optical axis, and each of the negative lens L11 and the positive lens L12 may be configured to be movable in a direction perpendicular to the optical axis.

In Examples 2 and 3 described above, the cemented lens CL11 is configured to be movable along the optical axis, but is not limited thereto. For example, the positive lens L13 may be configured to be movable along the optical axis, and each of the cemented lens CL11 and the positive lens L13 may be configured to be movable along the optical axis. The cemented lens CL11 may be configured to be movable in a direction perpendicular to the optical axis without being limited to the direction along the optical axis. In addition, the positive lens L13 may be configured to be movable in a direction perpendicular to the optical axis, and each of the cemented lens CL11 and the positive lens L13 may be configured to be movable in a direction perpendicular to the optical axis.

In Example 4 described above, the diffractive optical element DL1 having positive refractive power is configured to be movable along the optical axis, but is not limited thereto. For example, the diffractive optical element DL2 having negative refractive power may be configured to be movable along the optical axis, and each of the diffractive optical element DL1 having positive refractive power and the diffractive optical element DL2 having negative refractive power may be configured to be movable along the optical axis. The diffractive optical element DL1 having positive refractive power may be configured to be movable in a direction perpendicular to the optical axis without being limited to the direction along the optical axis. In addition, the diffractive optical element DL2 having negative refractive power may be configured to be movable in a direction perpendicular to the optical axis, and each of the diffractive optical element DL1 having positive refractive power and the diffractive optical element DL2 having negative refractive power may be configured to be movable in a direction perpendicular to the optical axis.

### EXPLANATION OF NUMERALS AND CHARACTERS

AL attachment optical system
OL objective lens
IL image forming lens

1. An attachment optical system for a microscope detachably mounted between an objective lens that receives light from an object and converts the light into parallel light and an image forming lens that forms an image with the light from the objective lens, the attachment optical system comprising:
a first optical element having negative refractive power; and
a second optical element having positive refractive power.

2. The attachment optical system according to claim 1, wherein at least one of the first optical element and the second optical element is movable along an optical axis.

3. The attachment optical system according to claim 1, wherein at least one of the first optical element and the second optical element is movable in a direction perpendicular to an optical axis.

4. The attachment optical system according to claim 1, wherein the following conditional expression is satisfied.
2<|fA/TLA<10000
where, fA: a focal length of the attachment optical system, and
TLA: an entire length of the attachment optical system

5. The attachment optical system according to claim 1, wherein the first optical element and the second optical element are disposed in order from the objective lens on an optical axis.

6. The attachment optical system according to claim 5, wherein the second optical element is one positive lens, or one cemented lens including at least a positive lens, and
the following conditional expression is satisfied.
35<νdP<101
where, νdP: an Abbe number of the positive lens

7. The attachment optical system according to claim 5, wherein the first optical element is one negative lens, or one cemented lens including at least a negative lens,
the second optical element is one positive lens, or one cemented lens including at least a positive lens, and
the following conditional expression is satisfied.
0≤νdp−νdN<30
where, νdP: an Abbe number of the positive lens, and
νdN: an Abbe number of the negative lens

8. The attachment optical system according to claim 1, wherein the first optical element is a diffractive optical element having negative refractive power,
the second optical element is a diffractive optical element having positive refractive power, and
the diffractive optical element having the positive refractive power and the diffractive optical element having the negative refractive power are disposed in order from the objective lens on an optical axis.

9. The attachment optical system according to claim 1, wherein the following conditional expression is satisfied.
$$0.1 < δ A / TLA < 4.5$$
where, δA: a distance on an optical axis from an optical surface closest to the objective lens in the attachment optical system to a back-side focal position of the objective lens, and
TLA: an entire length of the attachment optical system

10. The attachment optical system according to claim 1, wherein
the following conditional expression is satisfied.
$$0.05 < TLA / TLB < 0.75$$
where, TLA: an entire length of the attachment optical system, and
TLB: an entire length of the objective lens
